(19) United States
(12) Patent Application Publication
(10) Pub. No.: US 2025/0386180 A1
(43) Pub. Date: Dec. 18, 2025

(54) DISCARD TIMER SELECTION

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US)

(21) Appl. No.: 18/745,224

(22) Filed: Jun. 17, 2024

(51) Int. Cl. H04W 8/22; H04W 24/08; H04W 28/02; H04W 28/26

(52) U.S. Cl. CPC H04W 8/22; H04W 24/08; H04W 28/0268; H04W 28/26

(57) ABSTRACT

Methods, systems, and devices for wireless communications are described. For example, a user equipment (UE) may be capable of performing a discard timer selection procedure for a discard timer associated with a packet data convergence protocol (PDCP) layer of a protocol stack of the UE. The UE may receive, from the network entity, a control message indicating one or more selection parameters for the discard timer selection procedure of the UE. In response to receiving the control message, the UE may perform the discard timer selection procedure to obtain a discard timer value for the discard timer. The UE may store one or more PDCP service data units (SDUs) associated with an uplink message for the UE according to the selected discard timer value, such that one or more of the stored PDCP SDUs may be dropped upon expiration of an associated discard timer.

### FIELD OF TECHNOLOGY

The following relates to wireless communications, including discard timer selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support discard timer selection. For example, the described techniques enable a user equipment (UE) to perform a discard timer selection procedure for a discard timer associated with a packet data convergence protocol (PDCP) layer of a protocol stack of the UE. In some cases, the UE may receive, from the network entity, a control message indicating one or more selection parameters for the discard timer selection procedure of the UE. In response to receiving the control message, the UE may perform the discard timer selection procedure to obtain a discard timer value for the discard timer. The UE may store one or more PDCP service data units (SDUs) associated with an uplink message for the UE according to the selected discard timer value, such that one or more of the stored PDCP SDUs may be dropped upon expiration of an associated discard timer.

A method for wireless communications by a UE is described. The method may include receiving, based on a capability of the UE to perform a discard timer selection procedure for a discard timer associated with a PDCP layer of a protocol stack of the UE, a control message indicating one or more selection parameters for the discard timer selection procedure, performing, based on the one or more selection parameters, the discard timer selection procedure to obtain a discard timer value for the discard timer associated with the PDCP layer of the protocol stack of the UE, and storing, at a buffer associated with the protocol stack of the UE, one or more PDCP service data units (SDUs) associated with an uplink message for the UE, where the one or more PDCP SDUs are associated with one or more respective discard timers configured in accordance with the discard timer value obtained from the discard timer selection procedure.

A UE for wireless communications is described. The UE may include one or more memories storing processor executable code, and one or more processors coupled with the one or more memories. The one or more processors may individually or collectively be operable to execute the code to cause the UE to receive, based on a capability of the UE to perform a discard timer selection procedure for a discard timer associated with a PDCP layer of a protocol stack of the UE, a control message indicating one or more selection parameters for the discard timer selection procedure, perform, based on the one or more selection parameters, the discard timer selection procedure to obtain a discard timer value for the discard timer associated with the PDCP layer of the protocol stack of the UE, and store, at a buffer associated with the protocol stack of the UE, one or more PDCP SDUs associated with an uplink message for the UE, where the one or more PDCP SDUs are associated with one or more respective discard timers configured in accordance with the discard timer value obtained from the discard timer selection procedure.

Another UE for wireless communications is described. The UE may include means for receiving, based on a capability of the UE to perform a discard timer selection procedure for a discard timer associated with a PDCP layer of a protocol stack of the UE, a control message indicating one or more selection parameters for the discard timer selection procedure, means for performing, based on the one or more selection parameters, the discard timer selection procedure to obtain a discard timer value for the discard timer associated with the PDCP layer of the protocol stack of the UE, and means for storing, at a buffer associated with the protocol stack of the UE, one or more PDCP SDUs associated with an uplink message for the UE, where the one or more PDCP SDUs are associated with one or more respective discard timers configured in accordance with the discard timer value obtained from the discard timer selection procedure.

A non-transitory computer-readable medium storing code for wireless communications is described. The code may include instructions executable by one or more processors to receive, based on a capability of the UE to perform a discard timer selection procedure for a discard timer associated with a PDCP layer of a protocol stack of the UE, a control message indicating one or more selection parameters for the discard timer selection procedure, perform, based on the one or more selection parameters, the discard timer selection procedure to obtain a discard timer value for the discard timer associated with the PDCP layer of the protocol stack of the UE, and store, at a buffer associated with the protocol stack of the UE, one or more PDCP SDUs associated with an uplink message for the UE, where the one or more PDCP SDUs are associated with one or more respective discard timers configured in accordance with the discard timer value obtained from the discard timer selection procedure.

Some examples of the method, UEs, and non-transitory computer-readable medium described herein may further include operations, features, means, or instructions for performing, based on storing the one or more PDCP SDUs at the buffer, an SDU release procedure by dropping a PDCP SDU of the one or more PDCP SDUs from the buffer based on expiration of a respective discard timer for the PDCP SDU, the one or more respective discard timers including the respective discard timer for the PDCP SDU.

Some examples of the method, UEs, and non-transitory computer-readable medium described herein may further include operations, features, means, or instructions for performing, based on performing the SDU release procedure, one or more discard timer characteristic measurement procedures to obtain data associated with the discard timer associated with the PDCP SDU of the one or more PDCP SDUs, performing, based on performing the one or more discard timer characteristic measurement procedures, an update procedure to update a machine learning model of the UE according to the data, and performing, based on performing the update procedure, a second discard timer selection procedure to obtain an updated discard timer value for the discard timer using the updated machine learning model.

Some examples of the method, UEs, and non-transitory computer-readable medium described herein may further include operations, features, means, or instructions for performing, based on performing the second discard timer selection procedure, an accuracy monitoring procedure to determine whether the updated discard timer value satisfies one or more key performance indicators.

Some examples of the method, UEs, and non-transitory computer-readable medium described herein may further include operations, features, means, or instructions for transmitting a capability message indicating the capability of the UE to perform the discard timer selection procedure for the discard timer associated with the PDCP layer of the protocol stack of the UE, the capability of the UE associated with a source cell, a target cell, or both, and may be based on a buffer allocation value or buffer utilization threshold value, where the control message may be received in response to the capability message.

In some examples of the method, UEs, and non-transitory computer-readable medium described herein, performing the discard timer selection procedure may include operations, features, means, or instructions for inputting one or more model input parameters into a machine learning model, where the one or more model input parameters include one or more radio conditions, one or more performance target parameters, one or more wireless communication traffic conditions, or a combination thereof and obtaining, after inputting the one or more model input parameters, the discard timer value for the discard timer from an output of the machine learning model for the discard timer selection procedure.

Some examples of the method, UEs, and non-transitory computer-readable medium described herein may further include operations, features, means, or instructions for transmitting, after performance of the discard timer selection procedure, an indication of the discard timer value for the discard timer, where the discard timer value may be for a single cell or for handover to a target cell.

In some examples of the method, UEs, and non-transitory computer-readable medium described herein, performing the discard timer selection procedure may include operations, features, means, or instructions for obtaining the discard timer value using a machine learning model that may be based on the buffer utilization threshold value.

Some examples of the method, UEs, and non-transitory computer-readable medium described herein may further include operations, features, means, or instructions for receiving a configuration message indicating one or more model input parameters, where the one or more model input parameters include a maximum discard timer value, a minimum discard timer value, a maximum packet discard rate, or a combination thereof, where performing the selection procedure includes, inputting the one or more model input parameters into a machine learning model, and obtaining, after inputting the one or more model input parameters, the discard timer value for the discard timer from an output of the machine learning model for the discard timer selection procedure.

In some examples of the method, UEs, and non-transitory computer-readable medium described herein, performing the discard timer selection procedure may include operations, features, means, or instructions for obtaining one or more discard timer values using a machine learning model that may be based on the QoS value, the logical channel, the CC, and the cell group, or the combination thereof.

Some examples of the method, UEs, and non-transitory computer-readable medium described herein may further include operations, features, means, or instructions for receiving a configuration indicating one or more model input parameters, where the one or more model input parameters include an identifier for one or more cells associated with a network entity, one or more cell measurement configurations, or a combination thereof, where performing the discard timer selection procedure includes, inputting the one or more model input parameters into a machine learning model, and obtaining, after inputting the one or more model input parameters, the discard timer value for the discard timer from an output of the machine learning model for the discard timer selection procedure.

In some examples of the method, UEs, and non-transitory computer-readable medium described herein, performing the discard timer selection procedure may include operations, features, means, or instructions for obtaining the discard timer value using a machine learning model that may be based on the key performance indicator violation report, the over-discarding indication, and the latency value, or the combination thereof.

Some examples of the method, UEs, and non-transitory computer-readable medium described herein may further include operations, features, means, or instructions for performing the discard timer selection procedure to obtain the discard timer value, where the discard timer value fails to satisfy one or more performance targets and selecting, based on the discard timer value failing to satisfy the one or more performance targets, a second discard timer value for the discard timer according to a fallback procedure associated with the PDCP layer of the protocol stack of the UE.

A method for wireless communications by a network entity is described. The method may include obtaining a capability message indicating a capability of a UE to perform a discard timer selection procedure for a discard timer associated with a PDCP layer of a protocol stack of the UE, performing, based on the capability message, a selection parameter selection procedure to obtain one or more selection parameters for the discard timer selection procedure of the UE, and outputting, based on performing the selection parameter selection procedure, a control message indicating the one or more selection parameters.

A network entity for wireless communications is described. The network entity may include one or more memories storing processor executable code, and one or more processors coupled with the one or more memories. The one or more processors may individually or collectively be operable to execute the code to cause the network entity to obtain a capability message indicating a capability of a UE to perform a discard timer selection procedure for a discard timer associated with a PDCP layer of a protocol stack of the UE, perform, based on the capability message, a selection parameter selection procedure to obtain one or more selection parameters for the discard timer selection procedure of the UE, and output, based on performing the selection parameter selection procedure, a control message indicating the one or more selection parameters.

Another network entity for wireless communications is described. The network entity may include means for obtaining a capability message indicating a capability of a UE to perform a discard timer selection procedure for a discard timer associated with a PDCP layer of a protocol stack of the UE, means for performing, based on the capability message, a selection parameter selection procedure to obtain one or more selection parameters for the discard timer selection procedure of the UE, and means for outputting, based on performing the selection parameter selection procedure, a control message indicating the one or more selection parameters.

A non-transitory computer-readable medium storing code for wireless communications is described. The code may include instructions executable by one or more processors to obtain a capability message indicating a capability of a UE to perform a discard timer selection procedure for a discard timer associated with a PDCP layer of a protocol stack of the UE, perform, based on the capability message, a selection parameter selection procedure to obtain one or more selection parameters for the discard timer selection procedure of the UE, and output, based on performing the selection parameter selection procedure, a control message indicating the one or more selection parameters.

Some examples of the method, network entities, and non-transitory computer-readable medium described herein may further include operations, features, means, or instructions for obtaining, after outputting the control message, an indication of a discard timer value for the discard timer, where the discard timer value may be for a single cell or for handover to a target cell.

In some examples of the method, network entities, and non-transitory computer-readable medium described herein, the one or more selection parameters include a buffer utilization threshold value.

In some examples of the method, network entities, and non-transitory computer-readable medium described herein, the one or more selection parameters include a quality of service (QOS) value, a logical channel, a component carrier (CC), and a cell group, or a combination thereof.

In some examples of the method, network entities, and non-transitory computer-readable medium described herein, the one or more selection parameters include an identifier for one or more cells associated with the network entity.

In some examples of the method, network entities, and non-transitory computer-readable medium described herein, the one or more selection parameters include a key performance indicator violation report, an over-discarding indication, and a latency value, or a combination thereof.

### BRIEF DESCRIPTION OF THE DRAWINGS

FIG. 1 shows an example of a wireless communications system that supports discard timer selection in accordance with one or more aspects of the present disclosure.

FIG. 2 shows an example of a wireless communications system that supports discard timer selection in accordance with one or more aspects of the present disclosure.

FIG. 3 shows an example of a device that supports discard timer selection in accordance with one or more aspects of the present disclosure.

FIG. 4 shows an example of a process flow that supports discard timer selection in accordance with one or more aspects of the present disclosure.

FIG. 5 shows an example of a machine learning architecture that supports discard timer selection in accordance with one or more aspects of the present disclosure.

FIGS. 6 and 7 show examples of block diagrams that support discard timer selection in accordance with one or more aspects of the present disclosure.

FIGS. 8 through 14 show examples of process flows that support discard timer selection in accordance with one or more aspects of the present disclosure.

FIG. 15 shows an example of a machine learning architecture that supports discard timer selection in accordance with one or more aspects of the present disclosure.

FIGS. 16 and 17 show block diagrams of devices that support discard timer selection in accordance with one or more aspects of the present disclosure.

FIG. 18 shows a block diagram of a communications manager that supports discard timer selection in accordance with one or more aspects of the present disclosure.

FIG. 19 shows a diagram of a system including a device that supports discard timer selection in accordance with one or more aspects of the present disclosure.

FIGS. 20 and 21 show block diagrams of devices that support discard timer selection in accordance with one or more aspects of the present disclosure.

FIG. 22 shows a block diagram of a communications manager that supports discard timer selection in accordance with one or more aspects of the present disclosure.

FIG. 23 shows a diagram of a system including a device that supports discard timer selection in accordance with one or more aspects of the present disclosure.

FIGS. 24 and 25 show flowcharts illustrating methods that support discard timer selection in accordance with one or more aspects of the present disclosure.

### DETAILED DESCRIPTION

In some examples, a wireless communications protocol stack may include various layers that implement the functions and protocols for communicating information. A wireless communications protocol stack may include various layers that implement the functions and protocols for communicating information. For example, a network entity may transmit a message to a user equipment (UE) and, to generate the message, bits of message the network entity may pass through various layers of the protocol stack. At each layer of the protocol stack, the message may be received as a protocol data unit (PDU), altered in some way according to the functions of the layer, and then output to the next layer as a service data unit (SDU). In some examples, each SDU may be associated with a discard timer that may help prevent large quantities of SDUs from piling up at sending layer due to a slower receiving level that may not be able to receive the SDUs right away. The SDU discard timers may indicate to the UE a duration for which to buffer incoming SDUs at a layer before discarding the SDU.

For example, a network entity may transmit a message to a UE and, to generate the message, bits of message the network entity may pass through various layers of the protocol stack. At each layer of the protocol stack, the message may be received as a PDU, altered in some way according to the functions of the layer, and then output to the next layer as an SDU. In some examples, each SDU may be associated with a discard timer that may help prevent SDUs from exceeding a buffer storage capacity as lower layers process other SDUs (e.g., a lower layer may spend more time processing SDUs compared to the time spent by an upper layer to generate the SDUs. The SDU discard timers may indicate to the UE a duration for which to buffer incoming SDUs at a layer before discarding the SDU. In some techniques, the duration associated with the discard timer may be a static value controlled by the network entity. That is, the network entity may estimate a healthy service rate for the UE and set the duration of the discard timer accordingly. However, in some techniques, the network entity may not have access to information regarding the UE, such as memory usage, burst characteristics, and radio characteristics. Additionally, in some cases, a UE may perform a handover operation and buffer a relatively large quantity of data as SDUs are held without being processed as handover is completed, which may cause disruptions in communications. Because the network entity may not have access to these and other UE characteristics, static discard timer durations set by the network entity may result in increased latency and decreased efficiency in the wireless communications system.

To decrease latency and increase efficiency in a wireless communications system, a UE may be enabled to perform discard timer selection based on a machine learning (ML) model and according to a network entity-specified configuration. For example, a network entity may determine that a UE is capable of performing a discard timer selection procedure for a discard timer associated with a packet data convergence protocol (PDCP) layer of a protocol stack of the UE. The network entity may transmit a control message indicating various selection parameters for the discard timer selection procedure. The UE may receive the control message and may utilize the indicated parameters to perform the discard timer selection procedure to obtain a value for the discard timer. In response to obtaining a value for the discard timer, the UE may configure individual discard timers of PDCP SDUs according to the obtained value and may store the configured PDCP SDUs. In response to one or more of the individual discard timers of the stored PDCP SDUs expiring, the UE may perform an SDU release procedure to drop the associated SDUs from the UE.

Aspects of the disclosure are initially described in the context of wireless communications systems. Aspects of the disclosure are also described in the context of devices, process flows, machine learning architectures, communication managers, and block diagrams. Aspects of the disclosure are further illustrated by and described with reference to apparatus diagrams, system diagrams, and flowcharts that relate to discard timer selection.

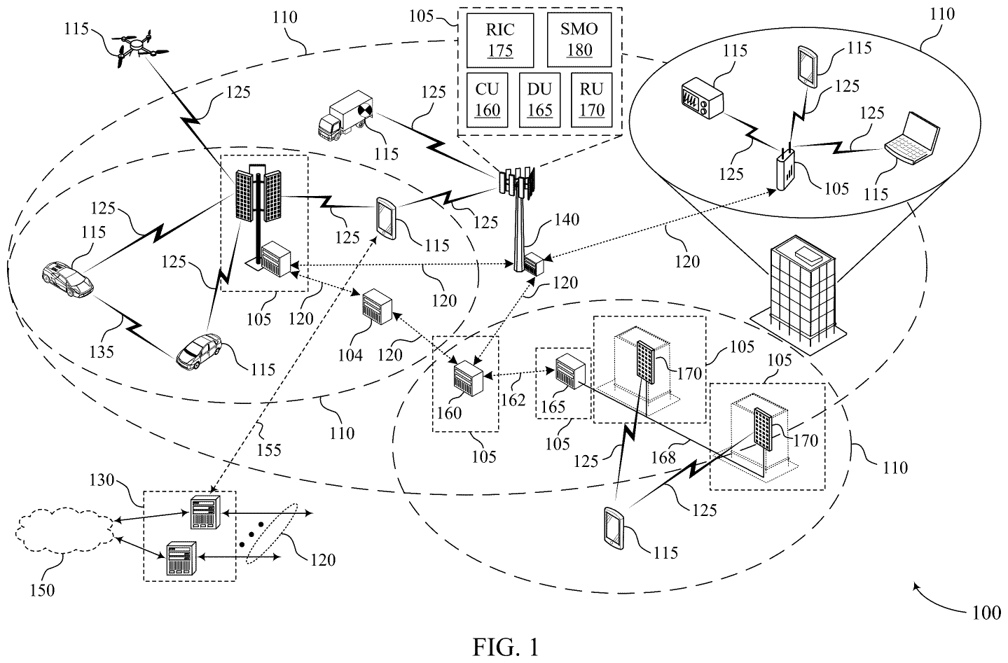

FIG. 1 shows an example of a wireless communications system 100 that supports discard timer selection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), PDCP). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the protocol stack may include various layers that implement the functions and protocols for communicating information. For example, the network entity 105 may transmit a message to the UE 115 and, to generate the message, bits of message the network entity 105 may pass through various layers of the protocol stack. At each layer of the protocol stack, the message may be received as a PDU, altered in some way according to the functions of the layer, and then output to the next layer as a SDU. In some examples, each SDU may be associated with a discard timer that may help prevent large quantities of SDUs from piling up at sending layer due to a receiving layer that may not be able to receive the SDUs right away. The SDU discard timers may indicate to the UE 115 a duration for which to buffer incoming SDUs at a layer before discarding the SDU. In some techniques, the duration associated with the discard timer may be a static value controlled by the network entity 105. That is, the network entity 105 may estimate a healthy service rate for the UE 115 and set the duration of the discard timer accordingly. However, in some techniques, the network entity 105 may not have access to information regarding the UE 115, such as memory usage, burst characteristics, and radio characteristics, and as such, static discard timer durations set by the network entity 105 may result in increased latency and decreased efficiency in the wireless communications system 100.

To decrease latency and increase efficiency in the wireless communications system 100, the UE 115 may be enabled to perform discard timer selection based on a ML or artificial intelligence (AI) model and according to a configuration specified by the network entity 105. For example, the network entity 105 may determine that the UE 115 is capable of performing a discard timer selection procedure for a discard timer associated with a PDCP layer of a protocol stack of the UE 115. The network entity 105 may transmit a control message indicating various selection parameters for the discard timer selection procedure. The UE 115 may receive the control message and may utilize the indicated parameters to perform the discard timer selection procedure to obtain a value for the discard timer. In response to obtaining a value for the discard timer, the UE 115 may configure individual discard timers of PDCP SDUs according to the obtained value and may store the configured PDCP SDUs. In response to one or more of the individual discard timers of the stored PDCP SDUs expiring, the UE 115 may perform an SDU release procedure to drop the associated SDUs from the UE 115.

Techniques of the present disclosure may enable UEs 115 to perform discard timer selection. Techniques described herein may decrease latency and increase efficiency of communication between the UEs 115 and the associated network entities 105 with respect to which parameters and characteristics are utilized for the discard timer selection procedure, thereby resolving any ambiguities or constraints caused by a network entity-controlled discard timer selection procedure. Discard selection procedures performed by the UEs 115 may enable efficient communications between the UEs 115 and the network entities 105 while reducing processing at the network entities 105. As such, techniques described herein may enable improved communication reliability and reduced latency at the UEs 115, which may lead to improved user experience related to reduced processing, more efficient utilization of communication resources, improved coordination between devices, and an improved utilization of processing capability.

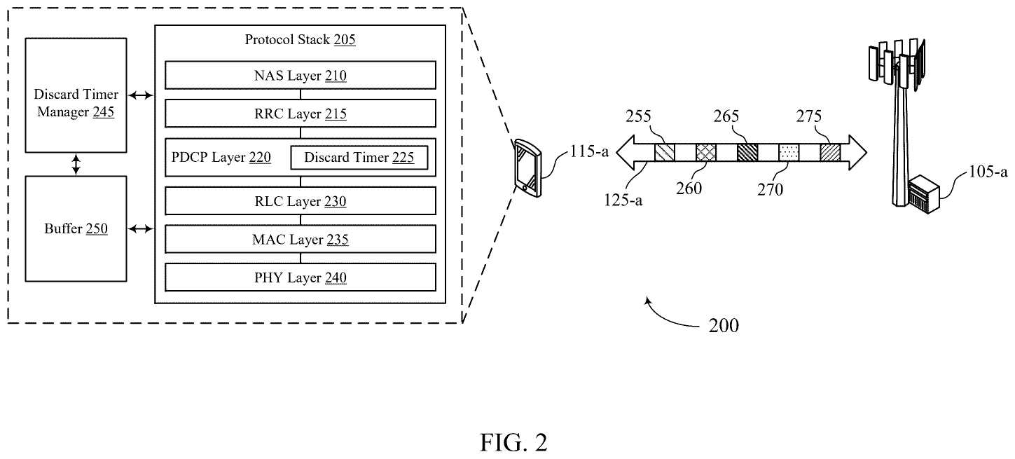

FIG. 2 shows an example of a wireless communications system 200 that supports discard timer selection in accordance with one or more aspects of the present disclosure. In some examples, the wireless communications system 200 may implement or be implemented by aspects of the wireless communications system 100 as described herein with reference to FIG. 1. For example, the wireless communications system 200 may include a UE 115-a and a network entity 105-a, which may be examples of UEs 115 and network entities 105 as described herein with reference to FIG. 1. The wireless communications system 200 may support 3G, 4G, 5G, or radio access technologies beyond 5G.

The UE 115-a and the network entity 105-a may perform wireless communication (e.g., one or more of receiving, obtaining, transmitting, or outputting one or more of control information or data) via a communication link 125-a, which may be examples of communications links 125 as described herein with reference to FIG. 1. In the example of FIG. 2, the UE 115-a may be equipped (e.g., configured) with at least one protocol stack 205 to support one or more of receiving, obtaining, transmitting, or outputting one or more of control information or data. The protocol stack 205 may include one or more protocol layers, which may be ordered in a hierarchical architecture. The protocol stack 205 may include one or more of a NAS layer 210, an RRC layer 215, a PDCP layer 220, an RLC layer 230, a MAC layer 235, or a PHY layer 240.

The various layers of the protocol stack 205 may implement functions and protocols for communicating information. For example, the network entity 105-a may transmit a message to the UE 115-a and, to generate the message, bits of message the network entity 105-a may pass through various layers of the protocol stack 205. At each layer of the protocol stack 205, the message may be received as a PDU, altered in some way according to the functions of the layer, and then output to the next layer as an SDU. For example, the NAS layer 210 may be capable of, configured to, or operable to support mobility, authentication, and bearer management for the UE 115-a served by the network entity 105-a. The RRC layer 215 may be capable of, configured to, or operable to support establishment, configuration, and maintenance of a connection between the UE 115-a and the network entity 105-a supporting radio bearers for user plane data. Additionally, the RRC layer 215 may be capable of, configured to, or operable to support establishment, configuration, and maintenance of a connection between a network entity 105 or a core network 130 supporting radio bearers for user plane data as described herein with reference to FIG. 1. The PDCP layer 220 may be capable of, configured to, or operable to support header compression, in-sequence delivery, ciphering and integrity protection, transfer of user plane and control plane data, removal of duplicates. Additionally, or alternatively, PDCP layer 220 may be capable of, configured to, or operable to support routing the split barriers. The RLC layer 230 may be capable of, configured to, or operable to support transfer of upper layer PDUs according one or more modes, and may support error correction, reassembly of RLC SDUs, and among other operations. The MAC layer 235 may be capable of, configured to, or operable to support priority handling and multiplexing of logical channels into transport channels. The PHY layer 240 may be capable of, configured to, or operable to support mapping transport channels to physical channels.

The UE 115-a may include a buffer 250. The buffer 250 may store one or more SDUs 275 (or PDUs) at the UE 115-a. In some examples, the buffer 250 may store one or more SDUs 275 that are pending submission to a following protocol stack layer. For example, the buffer 250 may store an SDU 275 that the PDCP layer 220 has received and not yet performed operations on. The buffer 250 may also store one or more SDUs 275 that have been submitted to a next (e.g., adjacent lower or upper) layer and are awaiting transmission. For example, the buffer 250 may store SDUs 275 that the PDCP layer 220 has received, performed operations on, submitted for transmission to the RLC layer 230, and that are waiting for availability in the RLC layer 230 (e.g., waiting to be transmitted). The buffer 250 may store SDUs 275 that have been transmitted to a lower layer, but for which the lower layer has not provided feedback. For example, the buffer 250 may store SDUs 275 that the UE 115-a transmits from the PDCP layer 220 to the RLC layer 230 until the RLC layer 230 acknowledges the SDUs 275.

The UE 115-a may include a discard timer manager 245. The discard timer manager 245 may monitor the discard timer 225 of the PDCP layer 220 and the individual discard timers associated with SDUs 275 stored in the buffer 250, and may discard the SDUs 275 associated with discard timers that have expired (e.g., based on the value of the discard timer 225). For example, the PDCP layer 220 may include one or more of the discard timers 225 for respective SDUs 275. Additionally, each of the SDUs 275 received from the RRC layer 215 and stored in the buffer 250 may be associated with individual discard timers. In some examples, each of the SDU discard timers may include a discard timer value indicating a duration associated with the storage of the SDU 275 in the buffer 250. The discard timer manager 245 may compare the discard timer values of the individual SDU discard timers to the value of the discard timer 225. In the case that a discard timer value of one or more of the SDU discard timers may satisfy the discard timer value of the discard timer 225 (e.g., the discard timer 225 expires), the discard timer manager 245 may initiate the release (e.g., discarding, dropping) of each associated SDU 275 from the buffer 250. In some examples, performing a release operation on SDUs 275 associated with expired discard timers 225 may help prevent the buffer 250 storage from being exceeded (e.g., by preventing SDUs 275 from being stored at the buffer 250 as the lower layer (e.g., the RLC layer 230) processes the SDUs 275.

In some techniques, the discard timer value associated with the discard timer 225 may be a static value controlled by the network entity 105-a. That is, the network entity 105-a may estimate a healthy service rate for the UE 115-a and set the duration of the discard timer 225 accordingly. However, in some techniques, the network entity 105-a may not have access to information regarding the UE 115-a, such as memory usage, burst characteristics, and radio characteristics. Additionally, in the case that the UE 115-a may perform a handover operation, the UE 115-a may buffer a relatively large quantity of data, which may cause disruptions. Because the network entity 105-a may not have access to the details of the UE 115-a, static discard timer durations set by the network entity 105-a may result in increased latency and decreased efficiency in the wireless communications system 200.

To decrease latency and increase efficiency in the wireless communications system 200, the UE 115-a may be enabled to perform discard timer value selection based on an ML model and according to a configuration specified by the network entity 105-a. For example, the network entity 105-a may determine that the UE 115-a is capable of performing a discard timer value selection procedure for the discard timer 225, and may transmit a control message 260 indicating various selection parameters for the discard timer selection procedure. The UE 115-a may receive the control message and may utilize the indicated parameters to perform the discard timer selection procedure to obtain a value for the discard timer 225. In response to obtaining a value for the discard timer 225, the UE 115-a may configure individual discard timers of the SDUs 275 according to the obtained value and may store the configured SDUs 275. In response to one or more of the individual discard timers of the stored PDCP SDUs expiring, the UE 115-a may perform an SDU 275 release procedure to drop the associated SDUs 275 from the UE 115-a. Enabling the UE 115-a to perform the discard timer value selection based on an ML model and according to a configuration specified by the network entity 105-a may result in increased efficiency and accuracy of the wireless communications system 200 (e.g., while operating within constraints placed by the network entity 105-a) due to a better estimate of memory usage, burst characteristics, buffer success rates (e.g., by means of status reports by the RLC layer 230), target cell link quality, and approximate buffer service rates, among others.

In the example of FIG. 2, the UE 115-a may transmit, and the network entity 105-a may receive, a capability message 255. The capability message 255 may indicate (e.g., to the network entity 105-a) a capability of the UE 115-a to perform a discard timer selection procedure for the discard timer 225. In some examples, the capability of the UE 115-a to perform the discard timer selection procedure may be associated with a source cell, a target cell, or a combination of both (e.g., or as separate capabilities). Additionally, or alternatively, the capability of the UE 115-a to perform the discard timer selection procedure may be based on a buffer allocation value or a buffer utilization threshold value, which may assist the network entity 105-a in setting a maximum discard timer bound.

The network entity 105-a may perform a selection parameter selection procedure. For example, in response to receiving the capability message 255, the network entity 105-a may perform a selection parameters selection procedure to obtain one or more selection parameters for the discard timer selection procedure of the UE 115-a. The selection parameters may include one or more various parameters for the discard timer selection procedure. For example, the selection parameters may include a buffer utilization threshold value, a QoS value, a logical channel, a CC, a cell group, an identifier for one or more cells associated with the network entity 105-b, a key performance indicator (KPI) violation report, an over-discarding indication, and a latency value, or a combination thereof.

The network entity 105-a may transmit, and the UE 115-a may receive, the control message 260. For example, based on the network entity 105-a performing the selection parameter selection procedure, the network entity 105-a may transmit the control message 260 indicating the one or more selection parameters to the UE 115-a. In some examples, the control message 260 may be transmitted in response to receiving the capability message 255 from the UE 115-a.

The network entity 105-a may transmit, and the UE 115-a may receive, a configuration message 265. For example, the network entity 105-a may transmit the configuration message 265 indicating one or more ML input (e.g., model input) parameters to the UE 115-a. In some examples, the ML input parameters may include an identifier for one or more cells associated with the network entity 105-b, one or more cell measurement configurations, or a combination thereof. In some other examples, the ML input parameters may include a maximum discard timer value, a minimum discard timer value, a maximum SDU (e.g., packet) discard rate, or a combination thereof. In some examples, the ML input parameters may include one or more radio conditions (e.g., average received power of a single resource element (RSRP), channel quality indicator (CQI), subcarrier spacing (SCS)), one or more performance target parameters (e.g., HARQ round trip time (RTT), RLC success/failure, observed latency, grant allocation statistics), one or more wireless communication traffic conditions, or a combination thereof.

Table 1 includes examples of parameters for managing the use of an ML model. For example, as described with reference to Table 1, the ML input parameters may be for the UE 115-a to utilize in configuring the ML model. The one or more ML inputs may include a minimum discard timer value (e.g., Min-Discard-Timer), which may be an example of a minimum value for the discard timer 225, and a maximum discard timer value (e.g., Max-Discard-Timer), may be an example of a maximum value for the discard timer 225. In some examples, the maximum discard timer value may function as a legacy discard timer value in the case that the ML model may be disabled. The one or more ML inputs may also include a maximum early discard value (e.g., Max-Early-Discard), which may be an example of an upper-bound KPI associated with the quantity of SDUs the UE 115-a may discard before adjusting (e.g., increasing) the discard timer value of the discard timer 225. In some examples, the maximum early discard value may be assessed over a sliding window timer duration. The one or more ML inputs may also include an early discard timer value (e.g., Early-Discard-Timer), which may be an example of a duration over which the maximum early discard value may be counted. The one or more ML inputs may include a buffer usage target value (e.g., Buffer-Usage-Target), which may be an example of a quantity of memory of the buffer 250 the UE 115-a should target for use. The buffer usage target value may be an example of a KPI that measures how much the UE 115-a may be over-discarding or under-discarding and may implicitly assess the ML model accuracy. In some examples, the remaining memory of the buffer 250 may be used to absorb bursts (e.g., the network entity 105-a may configure the UE 115-a to maintain 75% target buffer usage and may estimate that the rest of the 25% capacity of memory allocated is sufficient to absorb bursts). The one or more ML inputs may also include a ML model indicator (e.g., AIML_Allowed), which may be an example of an indication of whether the ML model may be utilized (e.g., whether the ML model is allowed). The one or more ML inputs may also include a QoS flow indicator (e.g., QoSFlowAllowed), which may be an example of an indication of whether the ML model may be utilized in a portion of the total QoS flows (e.g., whether the ML model may be applicable for some flows rather than all flows).

TABLE 1
Parameters to Manage the Use of the ML Model
Parameter

Min-Discard-Timer
Max-Discard-Timer
Max-Early-Discard
Early-Discard-Timer
Buffer-Usage-Target
AIML_Allowed
QoSFlowAllowed

Table 2 includes examples of parameters for predictive use of an ML model. In some examples, as described with reference to Table 2, the ML input parameters may be for the UE 115-a to utilize in configuring the ML model, such that the ML model may predict correct discard timer values for candidate target cells. In such a case, the ML input parameters may be similar to those described herein, with one or more additional ML input parameters. For example, the ML input parameters may include a cell ID value (e.g., Cell ID), which may be an example of an identifier for a candidate target cell. The ML input parameters may also include a measurement identifier value (e.g., Measurement-ID-to-predict), which may be an example of an identifier for one or more neighboring cell the ML model may utilize in predicting channel quality, congestion, RSRP, among other characteristics. By predicting correct discard timers, the ML model may ensure that prediction accuracy may be visible to the network entity 105-a and the UE 115-a, which may enable the UE 115-a to utilize a fallback discard timer in the case that the ML model may be misbehaving.

TABLE 2
Parameters for Predictive Use of the ML Model
Parameter

Cell ID
Min-Discard-Timer
Max-Discard-Timer
Buffer-Usage-Target
Measurement-ID-to-predict
AIML_Allowed
QoSFlowAllowed

The UE 115-a may perform a discard timer selection procedure. For example, in response to receiving the one or more selection parameters and the ML inputs, the UE 115-a may perform the discard timer selection procedure to obtain a discard timer value for the discard timer 225. In some examples, performing the discard timer selection procedure may include the UE 115-a inputting one or more of the received ML input parameters (e.g., as described with reference to Tables 1 and 2) into the ML model. In response to inputting the ML parameters into the ML model, the UE 115-a may obtain one or more discard timer values for the discard timer 225 from an output of the ML model. In some examples, the ML model may output different discard timer values for each selection parameter. For example, the ML model may output different timer values per each QoS flow, logical channel, CC, and cell group.

In some examples, the UE 115-a may select a discard timer value according to a fallback procedure. For example, the UE 115-a may perform the discard timer selection procedure to obtain a discard timer value, and the UE 115-a may determine that the obtained discard timer value fails to satisfy one or more performance targets (e.g., KPIs). In response to the discard timer value failing to satisfy the one or more performance targets, the UE 115-a may select a second discard timer value for the discard timer according to a fallback (e.g., default) procedure associated with the PDCP layer 220 of the protocol stack 205. In some examples, the UE 115-a may be required to fallback to a maximum discard timer value, send a KPI violation report to the network entity 105-a (e.g., or to the ML model server) reporting on the over-discarding or general throughout and latency of the UE 115-a, disable the ML model behavior for the associated QoS flow, or a combination thereof.

The UE 115-a may select the discard timer value based on a handover operation. For example, while performing a handover operation, the UE 115-a may experience one or more interruptions for a duration. During the interruption duration, a layer of the protocol stack 205 (e.g., the PDCP layer 220) may store one or more SDUs 275 according to the discard timer value. After performing the handover operations, the PDCP layer 220 of the receiving entity may transmit a status report indicating which of the SDUs 275 may have been transmitted successfully. The protocol stack 205 of the transmitting entity may receive the report and retransmit the SDUs 275 that may not have been transmitted successfully (e.g., utilizing the sequence numbers of the SDUs 275). The discard timer 225 (e.g., the UE 115-a) of the PDCP layer 220 may quantify (e.g., count) a maximum time utilized in transmitting one of the SDUs 275 successfully, and may update the discard timer value according to the maximum duration.

The UE 115-a may select the discard timer value based on a packet delay budget (PDB). For example, a RAN-specific PDB may be estimated by the network entity 105-a (e.g., or the UE 115-a). In some examples, it may be inefficient or useless to transmit an SDU 275 associated with a discard timer value that may exceed the value of the PDB. Thus, to help maintain space within a transmission queue for other SDUs 275 and to decrease wasted resources, the UE (e.g., the UE 115-a) may discard SDUs 275 when the discard timer value equals (e.g., or is near) the PDB value.

The UE 115-a may select the discard timer value based on a state of the UE 115-a or an environment associated with the UE 115-a. For example, the UE 115-a may perform an estimation operation to estimate memory usage associated with network traffic and radio conditions. In the case that the UE 115-a may predict a memory shortage, the UE 115-a may adjust the discard timer value for more aggressive discarding (e.g., a low discard timer value) to create space in memory. In some examples, the UE 115-a may perform one or more network traffic sojourn measurements. For example, the UE 115-a may monitor radio conditions and predict latency associated with delivery of the SDUs 275. The discard timer 225 may adjust the discard timer value according to the determined radio conditions and predicted latency. In some examples, the UE 115-a may predict various handover operations. Based on a determined handover event or a change in serving cells, the UE 115-a may adjust the discard timer value (e.g., increase the value, decrease the value). In some examples, the UE 115-a may adjust the discard timer value based on other traffic patterns and parameters. For example, the UE 115-a may measure or predict traffic flow, target throughput, latency, and reliability, and may utilize the measurements and predictions to increase or decrease the discard timer value. By monitoring a state or an environment of the UE 115-a, the UE 115-a may select values for the discard timer 225 that may allow the UE 115-a to store the SDUs 275 for an appropriate duration. Therefore, the aspects described herein may allow the UE 115-a to avoid setting too high of a discard timer value which may result in storing of SDUs 275 for excessive periods and/or avoid setting too low of a discard timer value which may result in premature discarding of SDU 275 that may still be relevant.

The UE 115-a may transmit, and the network entity 105-a may receive, a discard timer value indication 270. For example, after performing the discard timer selection procedure, the UE 115-a may transmit an indication of the discard timer value for the discard timer 225 to the network entity 105-a. In some examples, the discard timer value may be associated with a single cell or for a handover to a target cell. In some examples, the discard timer value indication 270 may indicate the selected discard timer value while, in other examples, the discard timer value indication 270 may indicate a recommendation to reconfigure the discard timer 225. The UE 115-a may transmit the discard timer value indication 270 in the form of an RRC, PDCP data, a control PDU, a MAC CE, or in another form. In the case that the UE 115-a may recommend a reconfiguration, the UE 115-a may transmit the discard timer value indication 270 via RRC (via UE assistance information (UAI)) or PDCP data control PDU, and the network entity 105-a may reply to the request with a MAC CE to reconfigure the timer, an ACK or NACK, a new discard timer value, or with a new PDCP configuration. In the case of a handover, the UE 115-a may inform the network entity 105-a of the selected discard timer value for the target cell that the UE 115-a may be targeting to apply. In some examples, this indication may be transmitted as part of pre-handover signaling which may assist the network entity 105-a in performing the handover operations but may rely on the ML model to operate aspects of the UE 115-a.

The UE 115-a may store one or more of the SDUs 275 according to the selected discard timer value. For example, in response to selecting the discard timer value for the discard timer 225, the UE 115-a may store the SDUs 275 at the buffer 250. While storing the SDUs 275 at the buffer 250, the UE 115-a may configure the individual discard timers of the SDUs 275 with the selected discard timer value obtained from the discard timer selection procedure.

The UE 115-a may perform a SDU release procedure. For example, based on storing the one or more SDUs 275 at the buffer 250, the UE 115-a may perform a SDU release procedure by dropping a SDU 275 from the buffer 250 in response to the discard timer associated with the SDU 275 expiring. In some examples, the discard timer manager 245 of the UE 115-a may perform the SDU release procedure, as described herein.

The UE 115-a may perform one or more measurement procedures. For example, in response to performing the SDU release procedure, the UE 115-a may perform one or more discard timer characteristic measurement procedures to obtain data associated with the SDU discard timer (e.g., the discard timer associated with the dropped SDU 275). In some examples, the collected data may include a different discard timer value associated with various aspects of the wireless communications system 200. For example, the UE 115-a may collect data associated with a discard timer value based on a serving cell, a bearer, QoS, and an associated logical channel, or a combination thereof. The UE 115-a may obtain this data to use in optimizing the SDU release procedure, such that the need for UE 115-a to perform SDU releases due to buffer overflow may be minimized. The UE 115-a may also perform one or more measurements procedures to obtain one or more discard timer values associated with recent SDU release procedures and determine how the values may change over a duration. By obtaining the change in the discard timer values over time, the UE 115-a may better predict discard times associated with target cells (e.g., discard timer values associated with handover operations), may better determine latency in processes associated with the SDUs 275, among other benefits.

The UE 115-a may perform one or more update procedures. For example, in response to performing the one or more discard timer characteristic measurement procedures, the UE 115-a may perform an update procedure to update the ML model according to the obtained data. In some examples, the UE 115-a may utilize the updated ML model to perform a second discard timer selection procedure such that the discard timer value for the discard timer 225 may be operable (e.g., up-to-date) according to the recently collected data. Additionally, or alternatively, the UE 115-a may perform one or more accuracy monitoring procedures. For example, in response to performing the second discard timer selection procedure, the UE 115-a may perform one or more accuracy monitoring procedures to determine whether the updated discard timer value satisfies one or more KPIs. The UE 115-a may continue to select discard timer values using the ML model, perform measurements, and update the ML model such that the selected discard timer value may be operable.

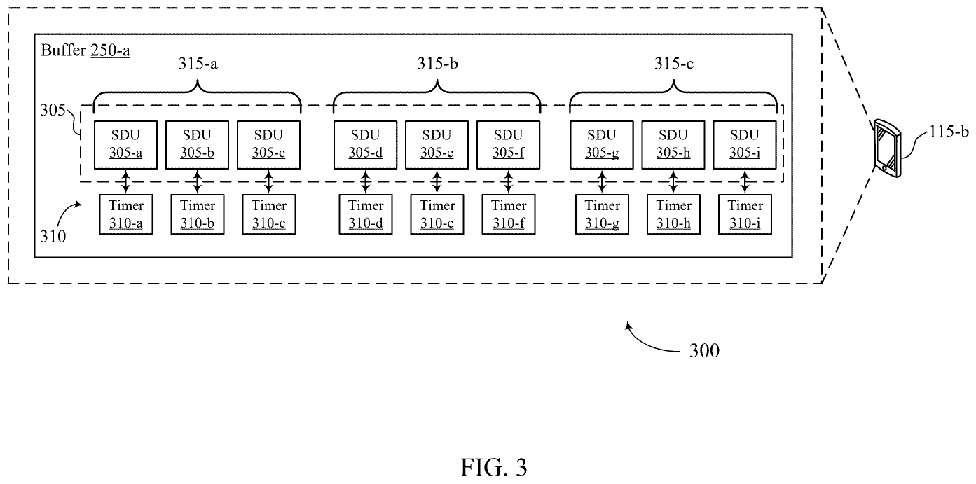

FIG. 3 shows an example of a device 300 that supports discard timer selection in accordance with one or more aspects of the present disclosure. In some examples, the device 300 may implement or be implemented by aspects of the wireless communications system 100 or the wireless communications system 200 as described herein with reference to FIGS. 1 and 2. For example, the device 300 may include a UE 115-b, which may be an example of UEs 115 as described herein with reference to FIGS. 1 and 2.

The UE 115-b may include a buffer 250-a, which may be an example of the buffer 250 as described herein with reference to FIG. 2. The buffer 250-a may store one or more SDUs 305, which may be examples of SDUs 275 as described herein with reference to FIG. 2. Each of the SDUs 305 may be associated with a respective discard timer of a set of discard timers 310. For example, SDU 305-a may be associated with discard timer 310-a. Each of the set of discard timers 310 may be associated with a discard timer value as described with more detail with reference to FIG. 2.

The buffer 250-a may store one or more SDUs 305 within the UE 115-b. The buffer 250-a may store an SDU group 315-a (e.g., the SDU 305-a, an SDU 305-b, an SDU 305-c) that may be awaiting submission to the RLC layer of the protocol stack. For example, the UE 115-b may receive the SDU 305-a, the SDU 305-b, and the SDU 305-c at the PDCP layer, perform one or more operations on the received SDUs 305, update the discard timers associated with the SDU group 315-a (e.g., discard timer 310-a, discard timer 310-b, discard timer 310-c) according to a selected discard timer value, and store the SDU group 315-a in the buffer 250-a until the UE 115-b submits the SDUs of the SDU group 315-a to the next layer of the protocol stack (e.g., the RLC layer).

The buffer 250-a may also store an SDU group 315-b (e.g., an SDU 305-d, an SDU 305-e, an SDU 305-f) that may be submitted to the RLC layer, but may be awaiting transmission to the RLC layer. For example, the UE 115-b may have previously received the SDU 305-d, the SDU 305-e, and the SDU 305-f at the PDCP layer, performed one or more operations on the received SDUs 305, updated the discard timers associated with the SDU group 315-b (e.g., a discard timer 310-d, a discard timer 310-e, a discard timer 310-f) according to the selected discard timer value, and stored the SDU group 315-b in the buffer 250-a. The UE 115-b may have also submitted the SDUs of the SDU group 315-b to the next layer of the protocol stack (e.g., the RLC layer), and the buffer 250-a may store the SDU group 315-b until the UE 115-b transmits the SDU group 315-b to the next layer.

The buffer 250-a may also store an SDU group 315-c (e.g., an SDU 305-g, an SDU 305-h, an SDU 305-i) that may be submitted to the RLC layer, but may be awaiting transmission to the RLC layer. For example, the UE 115-b may have previously received the SDU 305-g, the SDU 305-h, and the SDU 305-i at the PDCP layer, performed one or more operations on the received SDUs 305, updated the discard timers associated with the SDU group 315-c (e.g., a discard timer 310-g, a discard timer 310-h, a discard timer 310-i) according to the selected discard timer value, and stored the SDU group 315-c in the buffer 250-a. The UE 115-b may have also submitted the SDUs of the SDU group 315-c to the next layer of the protocol stack (e.g., the RLC layer), and transmitted the SDUs of the SDU group 315-c to the next layer of the protocol stack. In some examples, the buffer 250-a may store the SDU group 315-c until the receiving layer of the protocol stack (e.g., the RLC layer) transmits an acknowledgment (e.g., ACK, NACK) associated with receiving the SDUs of the SDU group 315-c.

The UE 115-b may perform an SDU release procedure on one or more of the SDUs 305. For example, the UE 115-b may include a discard timer manager that may monitor the discard timer of the PDCP layer and the individual discard timers of the set of discard timers 310 associated with the SDUs 305 stored in the buffer 250-a. The discard manager may discard the SDUs 305 associated with respective discard timers of the set of discard timers 310 that have expired (e.g., relative to the selected value of the discard timer of the PDCP layer). For example, the UE 115-b may determine that the discard timers (e.g., discard timer 310-a, discard timer 310-b, discard timer 310-c) associated with the SDU group 315-a may have expired prior to submitting the SDUs 305 of the SDU group 315-a to the RLC layer. In response to determining that the discard timers associated with the SDU group 315-a have expired, the UE 115-b may release (e.g., drop) the SDUs 305 of the SDU group 315-a from the buffer 250-a. Additionally, or alternatively, the UE 115-b may determine that the discard timers associated with the SDU group 315-b may have expired prior to transmitting the SDUs 305 of the SDU group 315-b to the RLC layer. In response to determining that the discard timers associated with the SDU group 315-b have expired, the UE 115-b may release (e.g., drop) the SDUs 305 of the SDU group 315-b from the buffer 250-a.

The UE 115-b (e.g., the discard manager of the UE 115-b) may also discard the SDUs 305 that have been successfully transmitted to a following protocol stack layer. For example, after transmitting the SDU group 315-c to the RLC layer, the UE 115-b may receive an acknowledgment of successful delivery from the RLC layer (e.g., an RLC ACK signal), as part of a PDCP status report, or a combination thereof. In response to the acknowledgment, the UE 115-b may release (e.g., drop) the SDUs 305 of the SDU group 315-c from the buffer 250-a. The respective discard timers (e.g., discard timer 310-g, discard timer 310-h, discard timer 310-i) of the set of discard timers 310 associated with the SDU group 315-c may not apply to or be utilized in SDU discard procedures on the SDU group 315-c, but the UE 115-c may transmit an indication of the set of discard timers 310 for use in handover operations.

Additionally, or alternatively, the UE 115-b may perform one or more SDU discard procedures on one or more SDUs 305 in the case that memory of the buffer 250-a may be utilized. For example, the UE 115-b may determine a quantity of filled memory within the buffer 250-a to satisfy a target buffer threshold value. The UE 115-b may be enabled to perform one or more SDU discard procedures on one or more SDUs 305 of the SDU groups 315 to release SDUs 305 from the buffer 250-a. In some examples, the UE 115-b may continue to perform SCU release procedures until the target buffer threshold value may be satisfied.

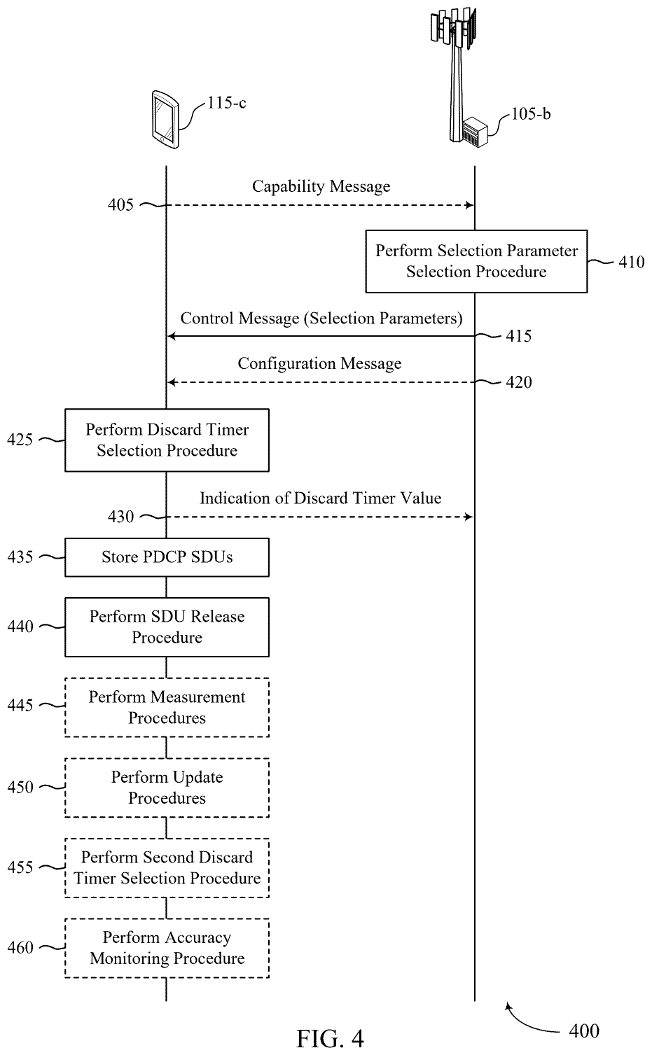

FIG. 4 shows an example of a process flow 400 that supports discard timer selection in accordance with one or more aspects of the present disclosure. Aspects of the process flow 400 may implement, or be implemented by, aspects of the wireless communications system 100, the wireless communications system 200, the device 300, or a combination thereof. For example, the process flow 400 illustrates signaling and configurations that enable a UE to perform discard timer selection based on an ML model and according to a configuration specified by a network entity.

The process flow 400 includes a UE 115-c and a network entity 105-b, which may be examples of UEs 115, network entities 105, and other wireless devices as described herein. For example, the UE 115-c and the network entity 105-b illustrated in FIG. 4 may include examples of the UE 115, a UE 115-a, a UE 115-b, the network entity 105, a network entity 105-a, or a combination thereof as described with reference to FIGS. 1 through 3, respectively.

In some examples, the operations illustrated in process flow 400 may be performed by hardware (e.g., including circuitry, processing blocks, logic components, and other components), code such as processor-executable code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the UE 115-c may transmit, and the network entity 105-b may receive, a capability message. The capability message may indicate (e.g., to the network entity 105-b) a capability of the UE 115-c to perform a discard timer selection procedure for a discard timer associated with a PDCP layer of a protocol stack of the UE 115-c. In some examples, the capability of the UE 115-c to perform the discard timer selection procedure may be associated with a source cell, a target cell, or a combination of both. Additionally, or alternatively, the capability of the UE 115-c to perform the discard timer selection procedure may be based on a buffer allocation value or a buffer utilization threshold value.

At 410, the network entity 105-b may perform a selection parameter selection procedure. For example, in response to receiving the capability message, the network entity 105-b may perform a selection parameters selection procedure to obtain one or more selection parameters for the discard timer selection procedure of the UE 115-c. The selection parameters may include one or more various parameters for the discard timer selection procedure. For example, the selection parameters may include a buffer utilization threshold value, a QoS value, a logical channel, a CC, a cell group, an identifier for one or more cells associated with the network entity 105-b, a KPI violation report, an over-discarding indication, and a latency value, or a combination thereof.

At 415, the network entity 105-b may transmit, and the UE 115-c may receive, a control message. For example, based on the network entity 105-b performing the selection parameter selection procedure, the network entity 105-b may transmit a control message indicating the one or more selection parameters to the UE 115-c. In some examples, the control message may be transmitted in response to receiving the capability message from the UE 115-c.

At 420, the network entity 105-b may transmit, and the UE 115-c may receive, a configuration message. For example, the network entity 105-b may transmit a configuration message indicating one or more ML input (e.g., model input) parameters to the UE 115-c. In some examples, the ML input parameters may include an identifier for one or more cells associated with the network entity 105-b, one or more cell measurement configurations, or a combination thereof. In some other examples, the ML input parameters may include a maximum discard timer value, a minimum discard timer value, a maximum SDU (e.g., packet) discard rate, or a combination thereof. In some examples, the ML input parameters may include one or more radio conditions, one or more performance target parameters, one or more wireless communication traffic conditions, or a combination thereof.

At 425, the UE 115-c may perform a discard timer selection procedure. For example, in response to receiving the one or more selection parameters, the UE 115-c may perform the discard timer selection procedure to obtain a discard timer value for the discard timer associated with the PDCP layer of the protocol stack of the UE 115-c. In some examples, performing the discard timer selection procedure may include the UE 115-c inputting one or more of the received ML input parameters into an ML model. In response to inputting the ML parameters into the ML model, the UE 115-c may obtain one or more discard timer values for the discard timer from an output of the machine learning model. That is, the UE 115-c may obtain one or more discard timer values from a ML model that may be based on the buffer utilization threshold value, the QoS value, the logical channel, the CC, and the cell group, the key performance indicator violation report, the over-discarding indication, and the latency value, or the combination thereof.

In some examples, the UE 115-c may select a discard timer value according to a fallback procedure. For example, the UE 115-c may perform the discard timer selection procedure to obtain a discard timer value, and may determine that the obtained discard timer value fails to satisfy one or more performance targets. In response to the discard timer value failing to satisfy the one or more performance targets, the UE 115-c may select a second discard timer value for the discard timer according to a fallback (e.g., default) procedure associated with the PDCP layer of the protocol stack of the UE.

At 430, the UE 115-c may transmit, and the network entity 105-b may receive, an indication of the discard timer value. For example, after performing the discard timer selection procedure, the UE 115-c may transmit an indication of the discard timer value for the discard timer to the network entity 105-b. In some examples, the discard timer value may be associated with a single cell or for a handover to a target cell.

At 435, the UE 115-c may store one or more PDCP SDUs. For example, the UE 115-c may store one or more PDCP SDUs that are associated with an uplink message for the UE 115-c at a buffer associated with the protocol stack of the UE 115-c. The PDCP SDUs may be associated with one or more respective discard timers. For example, each PSCP SDU may be associated with a discard timer that may be configured according to the discard timer value obtained from the discard timer selection procedure.

At 440, the UE 115-c may perform a PDCP SDU release procedure. For example, based on storing the one or more PDCP SDUs at the buffer, the UE 115-c may perform a PDCP SDU release procedure by dropping a PDCP SDU of the one or more PDCP SDUs from the buffer in response to an expiration of a respective discard timer for the PDCP SDU. That is, in the case that a discard timer associated with one of the PDCP SDUs may expire, the UE 115-c may drop the PDCP SDU associated with the expired discard timer.

At 445, the UE 115-c may perform one or more measurement procedures. For example, in response to performing the PDCP SDU release procedure, the UE 115-c may perform one or more discard timer characteristic measurement procedures to obtain data associated with the discard timer associated with the dropped PDCP SDU.

At 450, the UE 115-c may perform one or more update procedures. For example, in response to performing the one or more discard timer characteristic measurement procedures, the UE 115-c may perform an update procedure to update a ML model of the UE according to the obtained data.

At 455, the UE 115-c may perform a second discard timer selection procedure. For example, in response to performing the update procedure, the UE 115-c may perform a second discard timer selection procedure to obtain an updated discard timer value for the discard timer using the updated ML model.

At 460, the UE 115-c may perform an accuracy monitoring procedure. For example, in response to performing the second discard timer selection procedure, the UE 115-c may perform an accuracy monitoring procedure to determine whether the updated discard timer value satisfies one or more key performance indicators.

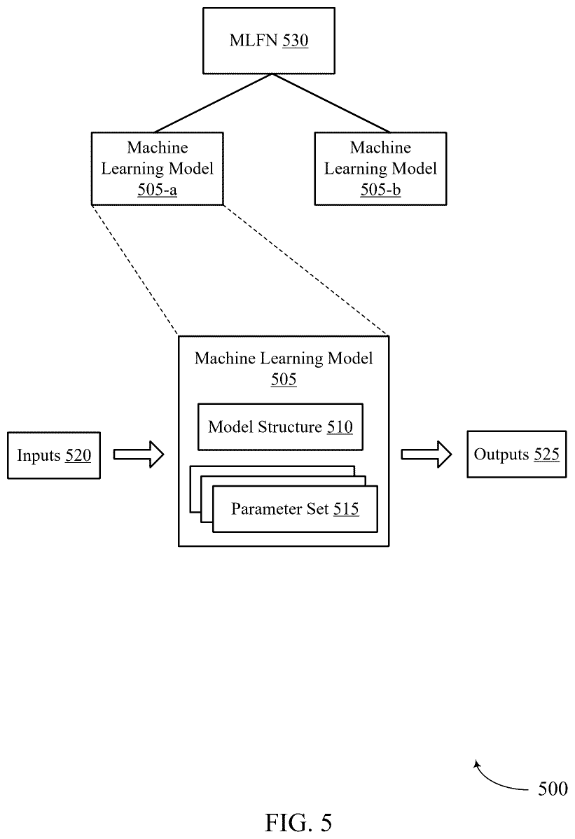

FIG. 5 shows an example of a machine learning architecture 500 that supports discard timer selection in accordance with one or more aspects of the present disclosure. The machine learning architecture 500 illustrates an implementation for machine learning models 505 (e.g., artificial intelligence models), which may be used to perform one or more of the features described herein.

A machine learning model 505 may generate a set of one or more outputs 525 based on a set of one or more inputs 520. For example, the machine learning model 505 may be a data driven model (e.g., algorithm), which uses machine learning techniques (e.g., artificial intelligence techniques) to generate the outputs 525. In some cases, the machine learning model 505 may be described using a model structure 510. For example, the machine learning model 505 may include one or more computation graphs, and the model structure 510 may define a structure for the machine learning model 505 for generating the outputs 525. In some examples, the machine learning model 505 may include one or more parameter sets 515. The parameter sets 515 may be neural network weights, for example, which may be used in combination with the model structure 510 to generate the outputs 525. In some examples, the machine learning model 505 (e.g., alone or in combination with other machine learning models 505) may implement a machine learning function (e.g., an artificial intelligence function) which may generate the outputs 525 based on the inputs 520.

In some examples, a machine learning feature name (MLFN) 530 may be used to identify a function performed by one or more machine learning models 505. For example, the MLFN 530 may correspond to CSI feedback, beam management, positioning, or other functionalities. In some cases, the one or more machine learning models 505 may be identified using a model ID. For example, the MLFN 530 may be associated with one or more model IDs corresponding to one or more machine learning models 505 (e.g., a machine learning model 505-a and a machine learning model 505-b). Each model ID may correspond to (e.g., and identify) a machine learning model 505 having a defined model structure 510, one or more parameter sets 515, or a combination thereof, as described herein. Additionally, or alternatively, a MLFN 530 may identify one or more machine learning models 505 using model structure IDs (e.g., MS IDs), parameter set IDs (E.g., PS IDs), or both. For example, the MLFN 530 may be associated with one or more model structure IDs, and each structure ID may identify a model structure 510 of a machine learning model 505. The MLFN 530 (e.g., or each structure ID) may also be associated with one or more parameter set IDs, each parameter set ID identifying a corresponding parameter set 515 for use with the corresponding model structure 510.

As such, model information may include MLFNs 530, model IDs, a model structure IDs, parameter set IDs, or a combination thereof. In some examples, each model ID may be associated with a model structure and one or more parameter sets, and may be represented by a string. For instance, the string may correspond to a flat namespace, such as a single value that represents a tuple that includes the model structure and the one or more parameter sets. Alternatively, the string may be a hierarchical namespace, such as the tuple including the model structure and the one or more parameter sets.

In some cases, each model ID may be unique with respect to a MLFN 530. For example, each model ID may identify a separate machine learning model 505 (e.g., for a vendor), and may be unique such that each model ID refers to a single corresponding machine learning model 505. Similarly, each model structure ID may also be unique with respect to a MLFN 530. In some cases, each model ID, model structure ID, or both, may be specific to a public land mobile network (PLMN). Additionally, or alternatively, the model IDs and model structure IDs may be standardized or may administered separately (e.g., per vendor) without standardizing.

A network entity 105 (e.g., a network) may configure and manage the use of machine learning models 505 for a UE 115. In some examples, the network entity 105 may manage machine learning at the UE 115 at a feature level, for example, by configuring the UE 115 by indicating a MLFN 530. Additionally, or alternatively, the network entity 105 may manage machine learning models 505 within each feature, and may configure the UE 115 using specific model IDs (e.g., indicating a model structure 510 and one or more parameter sets 515) corresponding to each feature. In some examples, the network entity 105 may manage the parameters of each machine learning model 505, and the network entity 105 may configure the UE 115 by indicating a model structure ID corresponding to a model structure 510 and one or more parameter sets 515. The parameter sets 515 may be explicitly indicated by the network entity 105 to the UE 115, which may allow for more flexibility of the parameters, and may reduce the storage requirements at the UE 115 for storing predetermined parameter sets 515. Alternatively, the network entity 105 may indicate the parameter sets 515 using one or more parameter IDs, which may reduce communication overhead between the UE 115 and the network entity 105.

In some examples, machine learning models 505 may be one-sided models, which may be performed entirely at a UE 115 or the network (e.g., at one or more network entities 105), or two-sided models, which may be performed at both the UE 115 and the network. One-sided models may be UE-side machine learning models 505, in which inference (e.g., running of the machine learning models 505) is performed at the UE 115. For example, the UE-side machine learning models 505 may involve non-UE specific inputs 520 (e.g., common to multiple UEs 115) and UE-specific inputs 520 (e.g., control inputs 520). In some cases, the UE 115 may receive control signaling or additional inputs 520 for the machine learning models 505 from a network entity 105, while the machine learning model 505 inference is performed entirely at the UE 115. Inference for network-side machine learning models 505 may be performed at the network (e.g., at one or more network entities 105), and the network may receive inputs 520 from the UE 115 to enter into the machine learning models 505. In some examples, the network may indicate the outputs 525 to the UE 115.

In two-sided machine learning models 505, joint inference may be performed. For example, one part of inference may be performed by the UE 115, and a remaining portion of the inference may be performed by one or more network entities 105. For example, the UE 115 may perform a first portion of the inference for a machine learning model 505, and the network may perform a second part of the inference (e.g., based on data received from the UE 115, for example). Alternatively, the network may perform the first portion of the inference for a machine learning model 505, and the UE 115 may perform the second part of the inference (e.g., based on data received from the network entity 105, for example). To perform inference for the two-sided machine learning model 505, a network entity 105 may signal one or more inputs 520 or other control signaling to the UE 115. Additionally, or alternatively, the UE 115 may transmit signaling indicating one or more inputs 520 or other control signaling to the network.

Accordingly, machine learning models 505 may be performed at a UE 115 or at one or more network entities 105, as managed by the network, to perform different functions that may improve the operations and efficiency of the UE 115 and the network as described herein.

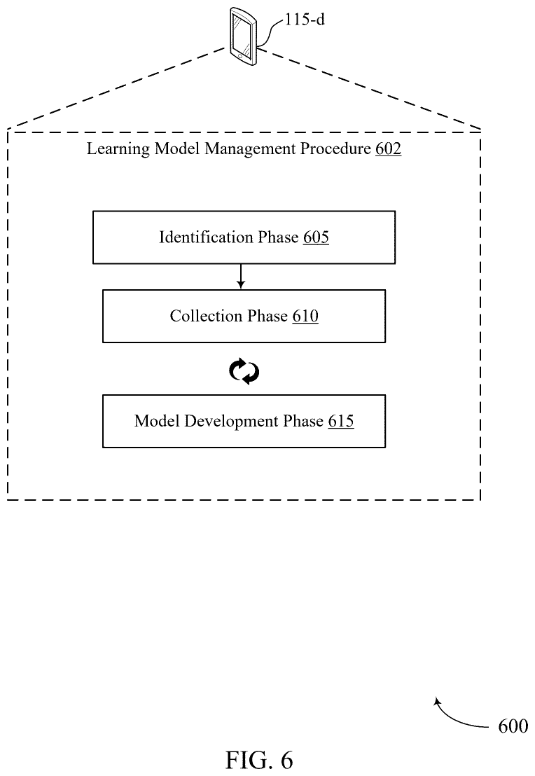

FIG. 6 shows an example of a block diagram 600 that supports discard timer selection in accordance with one or more aspects of the present disclosure. The UE 115-d may be an example of aspects of a UE 115 as described herein with reference to FIGS. 1 through 4, respectively. The UE 115-d may implement aspects of the wireless communications system 100 as described with reference to FIG. 1.

In the example of FIG. 6, the UE 115-d may support a learning model management procedure 602 associated with discard timer selection, as described herein. The learning model management procedure 602 may include one or more of an identification phase 605, a collection phase 610 (also referred to as a data collection phase), and a model development phase 615.

One or more operations of the learning model management procedure 602 may be implemented by the UE 115-d or components (e.g., one or more memories storing processor-executable code, one or more processors coupled with the one or more memories and individually or collectively operable to execute the code to cause the UE 115-d to perform the operations) as described herein. In the following description of the learning model management procedure 602, the one or more operations performed by the UE 115-d may be performed in different orders or at different times. Some operations may also be omitted from the learning model management procedure 602, and other operations may be added to the learning model management procedure 602.

During the identification phase 605, the UE 115-d may identify an opportunity of applying a learning model. For example, the UE 115-d may identify a machine learning feature (MLF) for development at the UE 115-d. The UE 115-d may determine a use case for the learning model. In some examples, the UE 115-d may determine a task (e.g., an action) associated with the learning model, may determine inputs and outputs of the learning model, or both.

During the collection phase 610, the UE 115-d may collect data. For example, the UE 115-d may collect data based on actions or measurements that the UE 115-d performs, or the UE 115-d may collect data from multiple network elements (e.g., UEs, network entities). The data collected may be used as an input to the learning model for model development.

During the model development phase 615, the UE 115-d may prepare the data (e.g., before inputting the data to the learning model, as part of inputting the data to the learning model). To prepare the data, the UE 115-d may utilize one or more data filters, one or more selection criteria, or other data preparation parameters or procedures. The UE 115-d may design the model. A design of the learning model may be based on the MLF, the data available to the UE 115-d, one or more target outputs of the learning model, or a combination thereof. The UE 115-d may train the learning model (e.g., using the input data), and the UE 115-d may perform validation and testing of the learning model. For example, the UE 115-d may determine an accuracy or a reliability of the learning model and may calculate one or more accuracy metrics of the learning model. In some examples, the UE 115-d may continue to collect data for the learning model until the learning model has reached a threshold accuracy or reliability.

In some examples, multiple models may be developed for a same MLF (e.g., a same use case). The different models may be applicable to difference deployment environments, scenarios, or regions (e.g., geographical regions). In some examples, learning models may be universal models and may be generalized models that are applicable across deployments (e.g., all deployments). Universal models may be device specific or hardware specific. Some learning models may be regional models which may be deployment specific or network specific. Regional models may be applicable to some deployments, networks, and/or regions, but not others. Some learning models may be local models which may be applicable to a specific cell or to a local geographical area.

In some examples, the UE 115-d may be capable of out-of-band or on-demand download of learning models. For example, because some models may be regional models or local models, the UE 115-d may download such learning models once the UE 115-d is in the field (e.g., on-demand downloading). In some examples, on-demand downloading of learning models at the UE 115-d may enable the UE 115-d to perform firmware over-the-air (FOTA) updates of existing models (e.g., downloaded models, such as out-of-band downloaded models), which may support federated learning of learning models.

Additionally, or alternatively, the model management procedure 602 may include a deployment of one or more learning models. For example, a UE 115-d may perform delivery or reception of a learning model (e.g., via an over the air interface or other signaling). That is, the UE 115-d may transmit an indication of the learning model to a network entity 105 or may receive an indication of the learning model from a network entity 105. In some examples, the indication of the learning model may indicate a partial model or a full model. A structure of the learning model may be known at a device receiving the learning model and the indication may include parameters for the model, or the indication may include a model (e.g., a model structure unknow by the receiving device) and parameters for the model.

In some examples, the indication of the learning model may include a model executable. The model executable may be optimized for different hardware platforms based on capabilities of the hardware platform and/or performance tradeoffs. The model executable may be downloaded directly to the UE 115-d or may be retrieved by the UE 115-d from a model repository. In some cases, due to a memory restriction at the UE 115-d, the learning model may be downloaded by the UE 115-d at runtime.

In some examples, the indication of the learning model may include one or more model management protocols. The model management protocols may include network and/or UE protocol functions to run the model. Additionally, or alternatively, the model management protocols may include layer 1 (L1)/layer 2 (L2) or RRC function handling (e.g., CSI type III support, MAC-control elements (MAC-CEs), RRC signaling for channel state feedback (CSF) configuration. In some cases, the model management protocols may include updated UE capabilities handling information (e.g., UE radio capability for CSF and supported CSF models).

In some examples, the UE 115-d may retrieve the learning model from one or more model repositories. The model repository may store the model to download (e.g., transfer) to the UE 115-d. In some examples, the model repository may be a server (e.g., mobile network operator (MNO)). A model and parameter set configuration (e.g., indicating a set of learning models to be downloaded to the UE 115-d) may be configurable (e.g., dynamic), or may be static. Downloading the learning model to the UE 115-d may be in accordance with a model download format. The model download format may be a binary executable file or image or may be a model descriptor or label (e.g., in accordance with an open neural network exchange (ONNX)). In some examples, model quantization and/or compilation may be during an out-of-band period or may be during a runtime period of the UE 115-d.

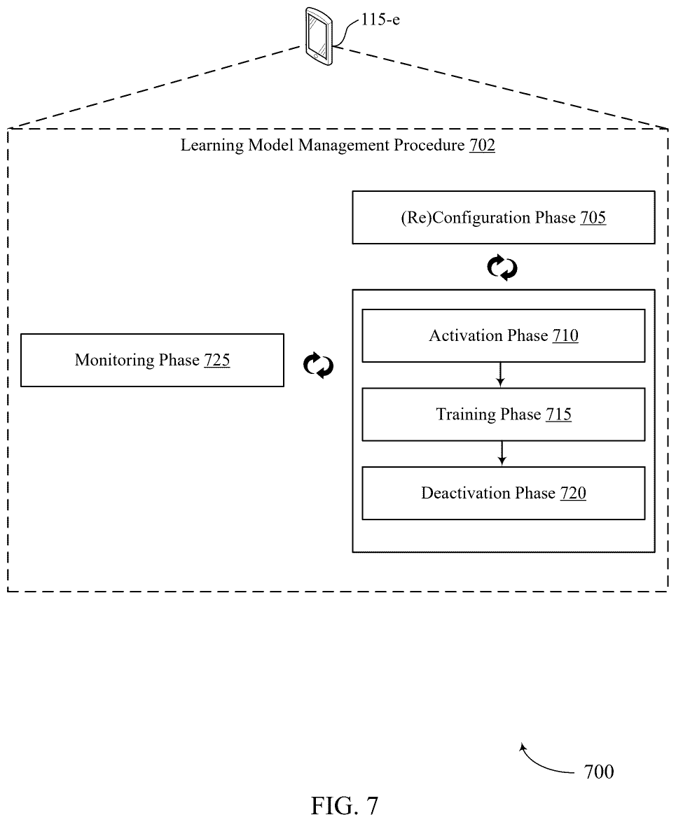

A learning model may undergo a life cycle, where the learning model progresses from one step of the life cycle to another. Steps of the model life cycle may include model development, model deployment, and model execution. For example, after development of a learning model, the learning model may be deployed. Based on model deployment, the UE 115-d may collect feedback of the learning model and may perform additional model development of the learning model (e.g., to improve or iterate on the learning model) based on the feedback. After model deployment, the learning model may be configured (e.g., for a particular use case, scenario), and the learning model may be executed by the UE 115-d (e.g., as described in greater detail with reference to FIG. 7). Based on model execution, the UE 115-d may collect feedback, may collect additional data, or both. The UE 115-d may perform model development of the learning model to improve the learning model based on the feedback and the additional data collected.

FIG. 7 shows an example of a block diagram 700 that supports discard timer selection in accordance with one or more aspects of the present disclosure. The UE 115-e may be an example of aspects of a UE 115 as described herein with reference to FIGS. 1 through 4, respectively. The UE 115-e may implement aspects of the wireless communications system 100 as described with reference to FIG. 1.

In the example of FIG. 7, the UE 115-e may support a learning model management procedure 702 associated with discard timer selection, as described herein. The learning model management procedure 702 may include one or more of a (re) configuration phase 705, an activation phase 710, a training phase 715 (also referred to as an inference phase), a deactivation phase 720, or a monitoring phase 725. The one or more learning models may be locally stored (e.g., one or more memories storing processor-executable code) at the UE 115-e. Alternatively, the UE 115-e may obtain (e.g., download) the one or more learning models, for example, via a network entity 105 or a network entity 105, as described herein with reference to FIGS. 1 and 2.

One or more operations of the learning model management procedure 702 may be implemented by the UE 115-e or components (e.g., one or more memories storing processor-executable code, one or more processors coupled with the one or more memories and individually or collectively operable to execute the code to cause the UE 115-e to perform the operations) as described herein. In the following description of the learning model management procedure 702, the one or more operations performed by the UE 115-e may be performed in different orders or at different times. Some operations may also be omitted from the learning model management procedure 702, and other operations may be added to the learning model management procedure 702.

During the (re) configuration phase 705, the UE 115-e may receive, from a network entity 105, a set of one or more configurations including a set of one or more parameters for configuring or reconfiguring one or more learning models (e.g., artificial intelligence models, machine learning models). The UE 115-e may receive, from a network entity 105, a request message for configuring or reconfiguring the one or more learning models. The request may include the set of one or more configurations and one or more identifiers associated with one or more learning models. The UE 115-e may transmit, to the network entity 105, a response message that includes an acknowledgment of the request message.

In some examples, the set of one or more parameters may be for managing (e.g., training, updating, modifying) the one or more learning models. In some other examples, the set of one or more parameters may be an input for the one or more learning models, for example, for inference of the one or more learning models. In other examples, the set of one or more parameters may be for monitoring one or more performance metrics (also referred to as KPIs) for the one or more learning models. Additionally, or alternatively, the set of one or more configurations may include one or more RRC configurations (e.g., one or more measurement configurations, one or more MAC configurations, or the like).

During the activation phase 710, the UE 115-e may activate at least one learning model (e.g., for at least one action). During the training phase 715, the UE 115-e may train the at least one learning model to obtain a set of one or more outputs based at least in part on a set of one or more inputs (e.g., a set of one or more parameters). During the deactivation phase 720, the UE 115-e may deactivate the at least one learning model (e.g., for at least one action).

During the monitoring phase 725, the UE 115-e may monitor (e.g., track) a performance of the at least one learning model. One or more of a network entity 105 or the UE 115-e may share (e.g., transmit, receive, exchange) feedback associated with the performance of the at least one learning model. The performance may be associated with a system performance (e.g., spectral efficiency, power consumption, delay, etc.) or a model performance (e.g., prediction accuracy, resource usage, inference delay, etc.). In some examples, one or more of a network entity 105 or the UE 115-e may trigger a switching event that includes switching (e.g., changing) from at least one learning model to at least one different learning model, for example, based at least in part on feedback associated with a performance of the at least one learning model. In some other examples, one or more of a network entity 105 or the UE 115-e may update the training of the at least one learning model based at least in part on the feedback associated with the performance of the at least one learning model.

The UE 115-e may switch from at least one learning model to at least one different learning model based at least in part on a function supported by the different learning model. In some examples, the UE 115-e may receive, from a network entity 105, a request message to switch to the at least one different learning model. The request message may indicate an identifier associated with the at least one different learning model, and the UE 115-e may identify the least one different learning model based at least in part on the identifier. During the activation phase 710 of the learning model management procedure 702, the UE 115-e may activate the at least one different learning model (e.g., a different artificial intelligence/machine learning model). Additionally, during the deactivation phase 720, the UE 115-e may deactivate the at least one learning model (e.g., a current artificial intelligence/machine learning model).

Additionally, or alternatively, during the monitoring phase 725, the UE 115-e may trigger the switching event based at least in part on a change in one or more parameters of the UE 115-e (e.g., a number of antennas, a number of carriers, etc.). In some examples, the UE 115-e may trigger the switching event based at least in part on a change in a location of the UE 115-e (e.g., a change from an indoor environment to an outdoor environment, or vice-versa). In some other examples, the UE 115-e may trigger the switching event based at least in part on a change in a service (e.g., network slice, QoS flow, session, etc.).

Accordingly, the UE 115-e may be configured to support managing (e.g., configuring, reconfiguring, activating, deactivating, monitoring, reporting, etc.) of one or more leaning models.

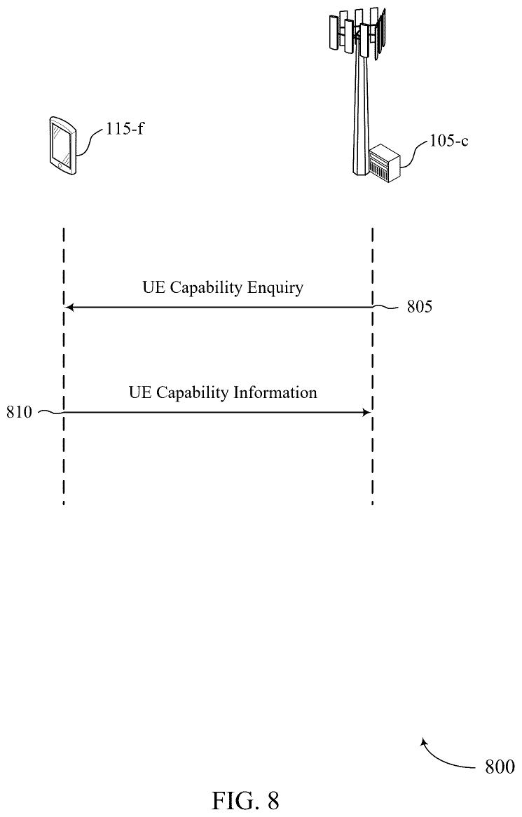

FIG. 8 shows an example of a process flow 800 that supports discard timer selection in accordance with one or more aspects of the present disclosure. The process flow 800 may implement aspects of the wireless communications system 100 as described with reference to FIG. 1. Additionally, or alternatively, the process flow 800 may implement or be implemented by, aspects of the wireless communications system 100, the wireless communications system 200, the device 300, or a combination thereof, as described herein with reference to FIGS. 1-3. The process flow 800 may include a UE 115-f and a network entity 105-c, which may be examples of UEs 115 and network entities 105 as described herein. In the following description of the process flow 800, the operations between the UE 115-f and the network entity 105-c may be transmitted in a different order than the example order shown, or the operations performed by the UE 115-f and the network entity 105-c may be performed in different orders or at different times. Some operations may also be omitted from the process flow 800, and other operations may be added to the process flow 800.

In the example of FIG. 8, the UE 115-f may support providing an indication to the network entity 105-c of one or more learning models, including one or more features for discard timer selection, supported by the UE 115-f. At 805, the network entity 105-c may transmit, and the UE 115-f may receive, a request message (e.g., a UE capability enquiry). The UE 115-f may determine, in response to the UE capability enquiry, a set of one or more UE capabilities. For example, the UE 115-f may determine whether the UE 115-f supports artificial intelligence/machine learning functionality, including one or more learning models (e.g., artificial intelligence/machine learning models) or one or more features associated with the one or more learning models.

At 810, the UE 115-f may transmit, and the network entity 105-c may receive, a response messages (e.g., UE capability information), in response to the request message. The UE capability information may include a set of one or more features supported by the UE 115-f. In some examples, the UE capability information may include a set of one or more identifiers associated with the one or more learning models, supported by the UE 115-f. Additionally, or alternatively, the UE capability information may include at least one field (e.g., information element (IE), flag, or the like) that indicates whether a corresponding learning model is loaded (e.g., initialized, stored, cached, or the like) at the UE 115-f. Additionally, or alternatively, the UE capability information may include a set of one or more identifiers associated with one or more learning model structures, or a set of one or more parameters for one or more features associated with the one or more learning model structures.

Accordingly, the UE 115-f may be configured to support exchange of UE capability information associated with one or more learning models.

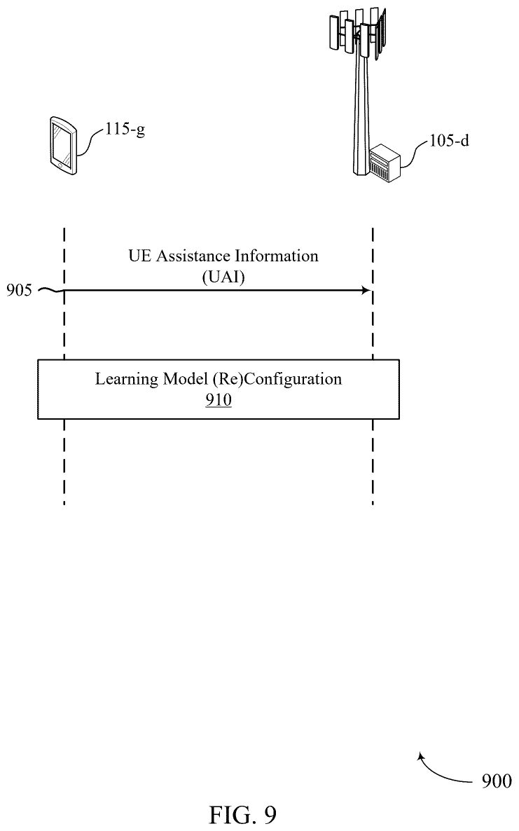

FIG. 9 shows an example of a process flow 900 that supports discard timer selection in accordance with one or more aspects of the present disclosure. The process flow 900 may implement aspects of the wireless communications system 100 as described with reference to FIG. 1. Additionally, or alternatively, the process flow 900 may implement or be implemented by aspects of the wireless communications system 100, the wireless communications system 200, the device 300, or a combination thereof, as described herein with reference to FIGS. 1-3. The process flow 900 may include a UE 115-g and a network entity 105-d, which may be examples of UEs 115 and network entities 105 as described herein. In the following description of the process flow 900, the operations between the UE 115-g and the network entity 105-d may be transmitted in a different order than the example order shown, or the operations performed by the UE 115-g and the network entity 105-d may be performed in different orders or at different times. Some operations may also be omitted from the process flow 900, and other operations may be added to the process flow 900.

In the example of FIG. 9, the UE 115-g may support providing UE assistance information (UAI) to the network entity 105-d. More specifically, the UE 115-g may support transmitting, to the network entity 105-d, UAI for managing one or more learning models. At 905, the UE 115-e may transmit, and the network entity 105-d may receive, UAI that may indicate one or more restrictions (also referred to as restricted UE capabilities) associated with the one or more learning models. For example, the restricted UE capabilities may include a set of one or more learning models, a set of one or more identifier associated with the set of one or more learning models, or both. In some examples, the restricted UE capabilities may exclude the set of one or more identifiers. In some examples, the UE 115-e may indicate a request to adjust (e.g., reduce, decrease, increase) a concurrency of the one or more learning models. For example, the UE 115-e may indicate a threshold number of concurrency (e.g., “maxartificial intelligencemachine learningconcurrency-Preference”) associated with the one or more learning models.

The UE 115-g may generate and transmit the UAI to the network entity 105-d based at least in part on a condition (e.g., an event). One or more examples of a condition may include, but is not limited to, a battery level of the UE 115-g satisfying a battery level threshold, a processor usage level of one or more processors of the UE 115-g satisfying a processor usage level threshold, or a heat level of one or more processors of the UE 115-g satisfying a heat level threshold. For example, the UE 115-g may transmit the UAI to the network entity 105-d to manage (e.g., deactivate, activate) one or more learning models at the UE 115-g based at least in part on one or more of the battery level of the UE 115-g satisfying the battery level threshold, the processor usage level of the one or more processors of the UE 115-g satisfying the processor usage level threshold, or the heat level of the one or more processors of the UE 115-g satisfying the heat level threshold.

Additionally, or alternatively, in some examples, the UAI may include a request for a set of one or more configurations associated with one or more learning models. In some examples, the UE 115-g may request the network entity 105-d for the set of one or more configurations associated with the one or more learning models based at least in part on a change in an environment of the UE 115-g. In some other examples, the UE 115-g may request the network entity 105-d for the set of one or more configurations associated with the one or more learning models based at least in part on a change in a state of the UE 115-g (e.g., a change between one or more of an idle state, an inactive state, or a connected state).

In other examples, the UE 115-g may request the network entity 105-d for the set of one or more configurations associated with the one or more learning models based at least in part on a session establishment associated with a network slice. For example, the UE 115-g may establish a session (e.g., a PDU session) associated with the network slice, and request the network entity 105-d for the set of one or more configurations associated with the one or more learning models. In some other examples, the UE 115-g may request the network entity 105-d for the set of one or more configurations associated with the one or more learning models based at least in part on a change in a geographic coverage area of the UE 115-g. For example, the UE 115-g may enter a new geographic coverage area of a cell, public land mobile network (PLMN), and request the network entity 105-d for the set of one or more configurations associated with the one or more learning models.

At least one configuration of the set of one or more configurations associated with provisioning of network data as input for one or more learning models (e.g., artificial intelligence/machine learning models). In some examples, the at least one configuration may indicate at least one identifier associated with at least one learning model supporting the network data as input to the least one learning model. In some examples, the UE 115-g may request (e.g., on-demand) for the network data from the network entity 105-d via the UAI, for example, based at least in part on the set of one or more configurations associated with provisioning of network data as input for one or more learning models (e.g., artificial intelligence/machine learning models).

At 910, one or more of the UE 115-g or the network entity 105-d may configure or reconfigure at least one learning model. For example, the network entity 105-d may select at least one learning model to deactivate at the UE 115-g, based at least in part on the UAI, and transmit control signaling (e.g., RRC, MAC-CE, DCI) for deactivating the at least one learning model. For example, the network entity 105-d may determine and select which learning model to deactivate at the UE 115-g based at least in part on the UAI, and transmit the control signaling (e.g., RRC, MAC-CE, DCI) that indicates for the UE 115-g to deactivate the at least one learning model. Additionally, or alternatively, the network entity 105-d may determine and select which learning model to configure or reconfigure and activate at the UE 115-g based at least in part on the UAI. For example, the network entity 105-d may determine and select which learning model to activate at the UE 115-g based at least in part on the UAI, and transmit control signaling (e.g., RRC, MAC-CE, DCI) that indicates for the UE 115-g to activate the at least one learning model.

Accordingly, the UE 115-g may be configured to support exchange of UAI for managing machine learning models that support discard timer selection for the UE 115-g.

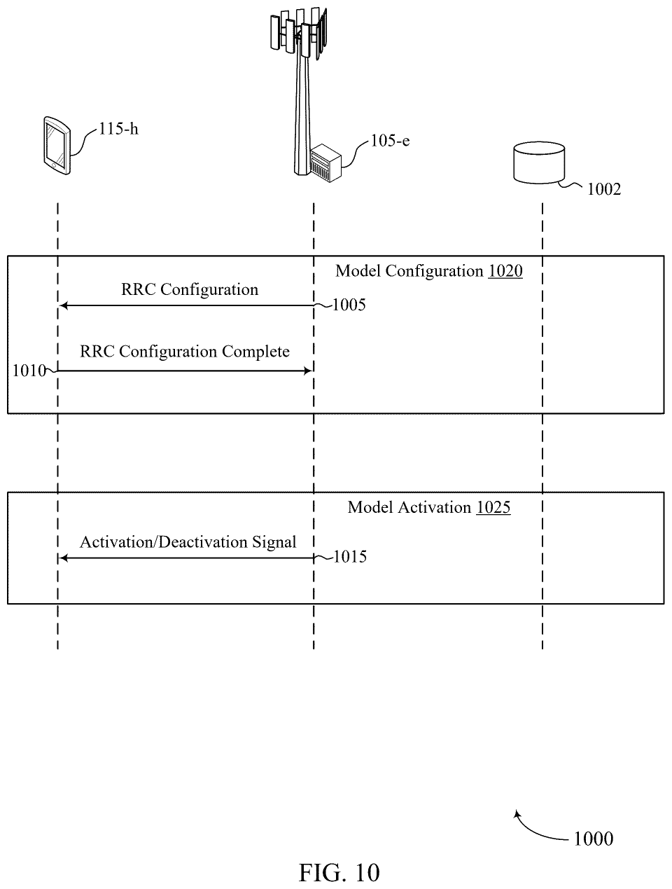

FIG. 10 shows an example of a process flow 1000 that supports discard timer selection in accordance with one or more aspects of the present disclosure. The process flow 1000 may implement aspects of the wireless communications system 100 or the wireless communications system 200, as described with reference to FIGS. 1 and 2. Additionally, or alternatively, the process flow 1000 may implement or be implemented by aspects of the device 300 as described herein with reference to FIG. 3. The process flow 1000 may include a UE 115-h and a network entity 105-c, which may be examples of UEs 115 and network entities 105 as described herein. Additionally, the process flow 1000 may include a repository 1002 (e.g., a database) storing one or more learning models. In the following description of the process flow 1000, the operations between the UE 115-h, the network entity 105-e, and the repository 1002 may be transmitted in a different order than the example order shown, or the operations performed by the UE 115-h, the network entity 105-e, and the repository 1002 may be performed in different orders or at different times. Some operations may also be omitted from the process flow 1000, and other operations may be added to the process flow 1000.

In the example of FIG. 10, one or more of the UE 115-h or the network entity 105-e may support performing a model configuration procedure 1020. The model configuration procedure 1020 may include an exchange of a set of one or more configurations (or a set of one or more parameters) associated with one or more learning models. The set of one or more configurations (or the set of one or more parameters) associated with the one or more learning models may be stored at the repository 1002 (e.g., a database, or the like), which the network entity 105-e may obtain from the repository 1002.

At 1005, the network entity 105-e may transmit, and the UE 115-h may receive, an RRC configuration message, which may include one or more sets of one or more configurations (or one or more sets of one or more parameters) associated with one or more learning models. The network entity 105-c may transmit, and the UE 115-h may receive, the RRC configuration message during an RRC configuration procedure. In some examples, the UE 115-h may configure one or more learning models via a layer 3 (L3) of the UE 115-h and based at least in part on the one or more sets of one or more configurations (or the one or more sets of one or more parameters) received in the RRC configuration message. At 1010, the UE 115-h may transmit, and the network entity 105-e may receive, an RRC configuration complete message, for example, based at least in part on the RRC configuration message. The RRC configuration complete message may indicate a completion of the RRC configuration procedure, including configuring of the one or more learning models.

In the example of FIG. 10, additionally, or alternatively, at least one configuration of the sets of one or more configurations may be for provisioning network data by the network entity 105-e to the UE 115-h for input to one or more learning models (e.g., artificial intelligence/machine learning models). In some examples, the at least one configuration may indicate at least one identifier associated with at least one learning model supporting the network data as input to the least one learning model. In some examples, the UE 115-h may request, the network entity 105-e, to activate or deactivate provisioning of network data as input to the at least one learning model via a MAC-CE. In some examples, the UE 115-h may receive, and the network entity 105-e may transmit, the network data via a unicast transmission and over a physical downlink channel (e.g., a physical downlink control channel (PDCCH), a physical downlink shared channel (PDSCH)). In some other examples, the UE 115-h may receive, and the network entity 105-e may transmit, the network data via a MAC-CE or an RRC message. In other examples, the UE 115-h may receive, and the network entity 105-e may transmit (e.g., broadcast), the network data via system information or a multicast broadcast service (MBS) transmission.

Additionally, or alternatively, at least one configuration of the sets of one or more configurations may be for provisioning, to the network entity 105-e, UE data as input for one or more learning models (e.g., artificial intelligence/machine learning models). In some examples, the at least one configuration may indicate at least one identifier associated with at least one learning model supporting the UE data as input to the least one learning model. The network entity 105-e may request, from the UE 115-h, to activate or deactivate provisioning of UE data as input to the at least one learning model via a MAC-CE. In some examples, the UE 115-h may transmit, and the network entity 105-e may receive, UE data via a unicast transmission and over a physical uplink channel (e.g., a physical uplink control channel (PUCCH), a physical uplink shared channel (PUSCH)). In some other examples, the UE 115-h may transmit, and the network entity 105-e may receive, the UE data via a MAC-CE or an RRC message.

At 1015, the network entity 105-e may transmit, and the UE 115-h may receive, a signal (also referred to as an activation signal or a deactivation signal) for activating or deactivating one or more learning models. In some examples, the network entity 105-e may transmit, and the UE 115-h may receive via a layer 2 (L2) of the UE 115-h, the signal for activating or deactivating the one or more learning models. For example, the network entity 105-e may transmit, and the UE 115-h may receive, a MAC-CE that activates or deactivates the one or more learning models. In some examples, activating or deactivating the one or more learning models may be based at least in part on a switching event as described herein with reference to FIGS. 5 through 7.

Accordingly, one or more of the UE 115-h or the network entity 105-e may be configured to support managing machine learning models based at least in part on activating or deactivating one or more learning models via MAC-CE, which may support discard timer selection as described herein.

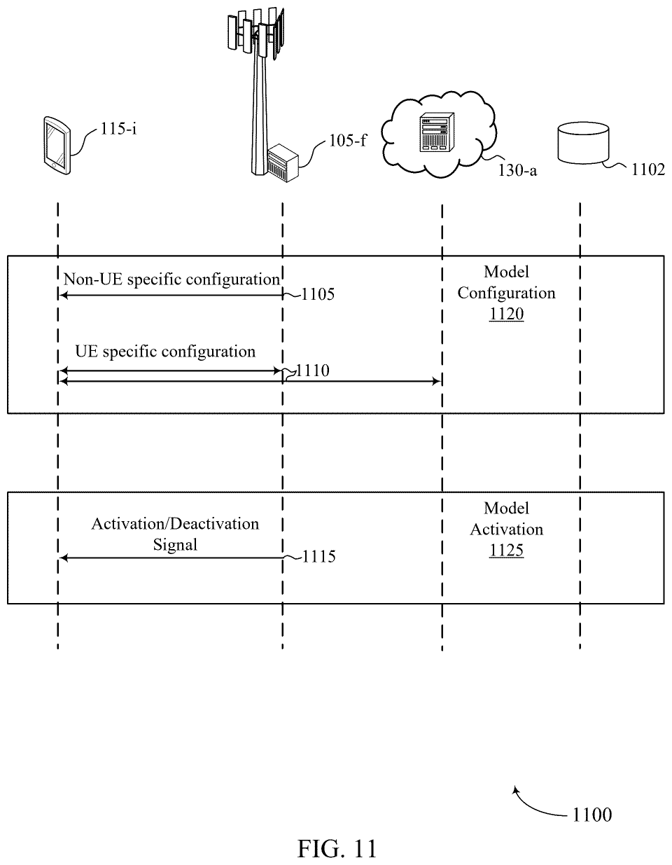

FIG. 11 shows an example of a process flow 1100 that supports discard timer selection in accordance with one or more aspects of the present disclosure. The process flow 1100 may implement aspects of the wireless communications system 100, the wireless communications system 200, the device 300, or a combination thereof, as described with reference to FIGS. 1-3. The process flow 1100 may include a UE 115-i, a network entity 105-f, and a core network 130-a, which may be examples of UEs 115, network entities 105, and core networks 130 as described herein. Additionally, the process flow 1100 may include a repository 1102 (e.g., a database) storing one or more learning models. In the following description of the process flow 1100, the operations between the UE 115-i, the network entity 105-f, the core network 130-a, and the repository 1102 may be transmitted in a different order than the example order shown, or the operations performed by the UE 115-i, the network entity 105-f, the core network 130-a, and the repository 1102 may be performed in different orders or at different times. Some operations may also be omitted from the process flow 1100, and other operations may be added to the process flow 1100.

In the example of FIG. 11, one or more of the UE 115-i, the network entity 105-f, or the core network 130-a may support performing one or more procedures, which may exchange of a set of one or more configurations (or a set of one or more parameters) associated with one or more learning models. For example, one or more of the UE 115-i, the network entity 105-f, or the core network 130-a may support performing one or more procedures, which may exchange of the set of one or more configurations (or the set of one or more parameters) associated with the one or more learning models based at least in part on a state (e.g., an idle state, an inactivate state) of the UE 115-i. In some examples, one or more of the UE 115-i, the network entity 105-f, or the core network 130-a may support activating or deactivating the one or more learning models for inference during the state of the UE 115-i. For example, one or more of the UE 115-i, the network entity 105-f, or the core network 130-a may support activating or deactivating the one or more learning models to perform an inference (e.g., training) of the one or more learning models and cell selection, cell reselection, RLF recovery, measurement operations, random access channel operations (e.g., beam selection, random access channel occasions (RO), and the like).

At 1105, the network entity 105-f may transmit, and the UE 115-i may receive, a set of one or more non-UE specific configurations. For example, the network entity 105-f may broadcast, and the UE 115-i may receive, system information including the set of one or more non-UE specific configurations. The system information may include a system information block (SIB). The set of one or more non-UE specific configurations may include one or more sets of one or more parameters, which may be associated with a set of one or more learning models and include a set of one or more identifiers associated with the set of one or more learning models, etc.

Additionally, or alternatively, at 1110, the network entity 105-f may transmit, and the UE 115-i may receive, for example, via a unicast transmission, a set of one or more UE specific configurations for discard timer selection, as described herein. For example, the network entity 105-d may transmit, and the UE 115-i may receive, an RRC message including the set of one or more UE specific configurations. The set of one or more UE specific configurations may include one or more sets of one or more parameters, which may be associated with a set of one or more learning models including a set of one or more identifiers associated with the set of one or more learning models. In some examples, the RRC message may be an RRC release message during an RRC release procedure. In some examples, one or more of the UE 115-i, the network entity 105-f, or the core network 130-a (e.g., one or more network functions associated with the core network 130-a) may exchange one or more NAS messages associated with the set of one or more UE specific configurations.

At 1115, the network entity 105-f may transmit, and the UE 115-i may receive, a signal (also referred to as an activation signal or a deactivation signal) for activating or deactivating one or more learning models. In some examples, the network entity 105-f may transmit, and the UE 115-i may receive, the signal for activating or deactivating the one or more learning models. For example, the network entity 105-f may transmit, and the UE 115-i may receive, a MAC-CE that activates or deactivates the one or more learning models and may perform an inference (e.g., training) of the one or more learning models during an idle state or an inactivate state of the UE 115-i. As such, activating or deactivating the one or more learning models may be based at least in part on the idle state or the inactivate state of the UE 115-i.

Accordingly, one or more of the UE 115-i, the network entity 105-f, or the core network 130-a may support activating or deactivating one or more learning models and for inference of the one or more learning models during an idle state or an inactivate state of the UE 115-i.

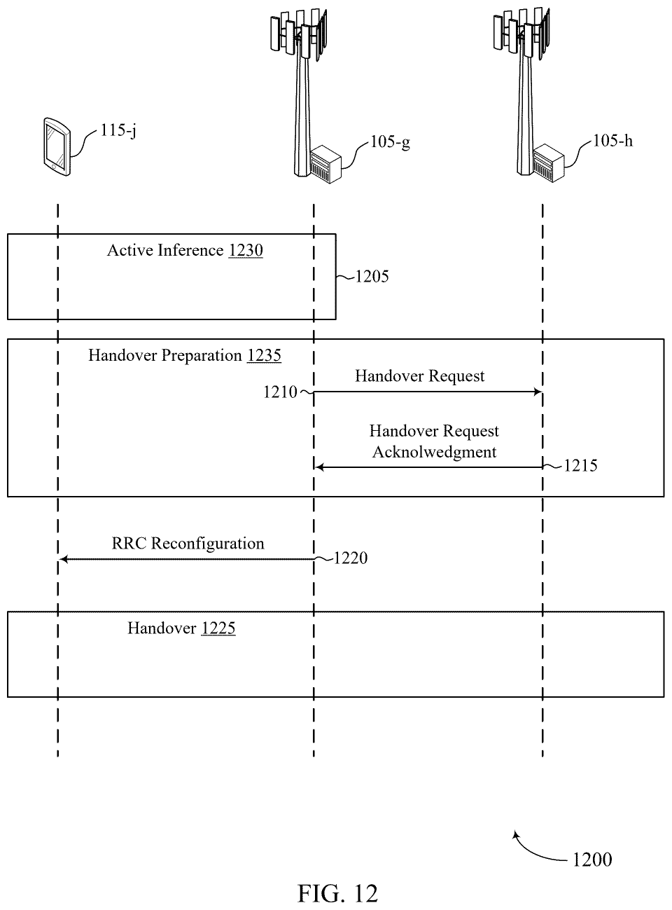

FIG. 12 shows an example of a process flow 1200 that supports discard timer selection in accordance with one or more aspects of the present disclosure. The process flow 1200 may implement aspects of the wireless communications system 100, the wireless communications system 200, the device 300, or a combination thereof, as described with reference to FIGS. 1-3. The process flow 1200 may include a UE 115-j, a network entity 105-g, and a network entity 105-h, which may be examples of UEs 115 and network entities 105 as described herein. In the following description of the process flow 1200, the operations between the UE 115-j, the network entity 105-g, and the network entity 105-h may be transmitted in a different order than the example order shown, or the operations performed by the UE 115-j, the network entity 105-g, and the network entity 105-h may be performed in different orders or at different times. Some operations may also be omitted from the process flow 1200, and other operations may be added to the process flow 1200.

In the example of FIG. 12, one or more of the UE 115-j, the network entity 105-e, and the network entity 105-h may support managing machine learning models for discard timer selection during a mobility (also referred to as UE mobility) of the UE 115-j. More specifically, one or more of the UE 115-j, the network entity 105-g, and the network entity 105-h may support managing artificial intelligence/machine learning functionality associated with the UE 115-j during a handover procedure, which may include switching (e.g., transferring) a connection of the UE 115-j from the network entity 105-g (also referred to as a source base station) to the network entity 105-h (also referred to as a target base station) and while maintaining ongoing artificial intelligence/machine learning functionality.

At 1205, one or more of the UE 115-j or the network entity 105-g may perform an active inference operation 1230 (e.g., training) of one or more learning models. The inference (e.g., training) of the one or more learning models may be based at least in part on one or more sets of one or more configurations, including one or more sets of one or more parameters, configured by the network entity 105-g.

At 1210, the network entity 105-g may transmit, and the network entity 105-f may receive, a handover request message, which may include context information (e.g., artificial intelligence/machine learning context) associated with the one or more learning models. At 1215, the network entity 105-h may transmit, and the network entity 105-g may receive, a handover request acknowledgment message, which may include one or more sets of one or more configurations, including one or more sets of one or more parameters, configured by the network entity 105-h. Put another way, the network entity 105-h may provide a set of one or more artificial intelligence/machine learning configurations for the UE 115-j to apply after being handed over to the network entity 105-h by the network entity 105-g. In some examples, the network entity 105-g may determine the sets of one or more configurations, including the one or more sets of one or more parameters, based at least in part on the context information (e.g., artificial intelligence/machine learning context) received from the network entity 105-h. Additionally, or alternatively, the network entity 105-g may determine the sets of one or more configurations, including the one or more sets of one or more parameters, based at least in part on one or more of UE capabilities of the UE 115-j or network capabilities of the network entity 105-h. In some examples, one or more of the UE 115-j or the network entity 105-h may support partial or full artificial intelligence/machine learning functionality (e.g., enabling of one or more features associated with at least one learning model).

At 1220, the network entity 105-g may transmit, and the UE 115-j may receive, an RRC reconfiguration message, which include the sets of one or more configurations, including the one or more sets of one or more parameters, configured by the network entity 105-h. At 1225, one or more of the UE 115-j, the network entity 105-g, or the network entity 105-f may complete the handover procedure.

Accordingly, one or more of the UE 115-j, the network entity 105-g, or the network entity 105-h may support selecting a reordering timer for the UE 115-j using one or more machine learning models.

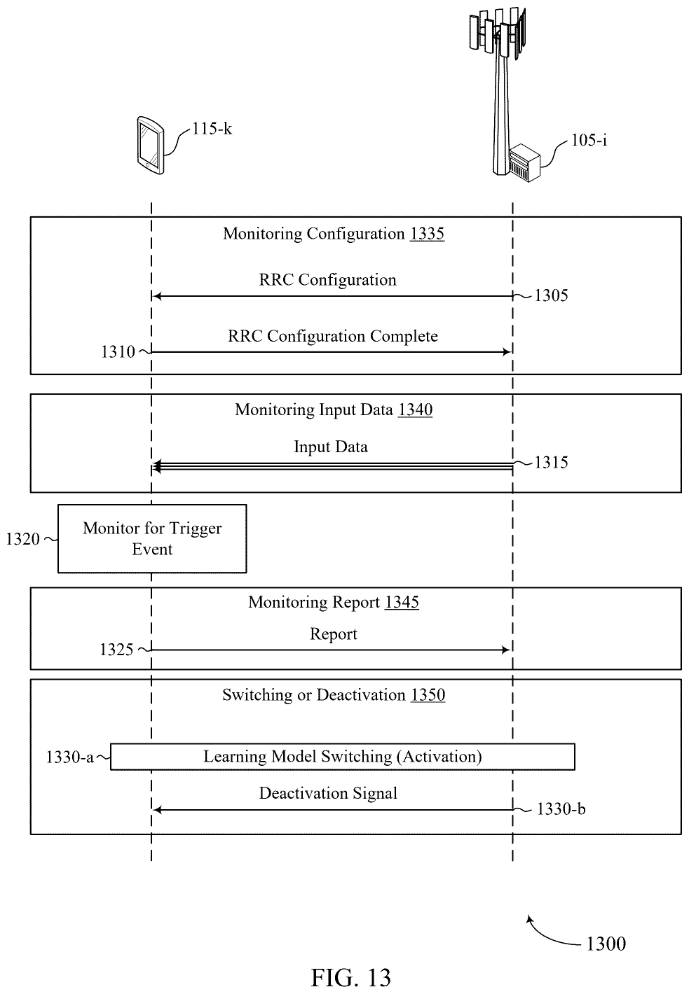

FIG. 13 shows an example of a process flow 1300 that supports discard timer selection in accordance with one or more aspects of the present disclosure. The process flow 1300 may implement aspects of the wireless communications system 100, the wireless communications system 200, the device 300, or a combination thereof, as described with reference to FIGS. 1-3. The process flow 1300 may include a UE 115-k and a network entity 105-i, which may be examples of UEs 115 and network entities 105 as described herein. In the following description of the process flow 1300, the operations between the UE 115-k and the network entity 105-i may be transmitted in a different order than the example order shown, or the operations performed by the UE 115-k and the network entity 105-i may be performed in different orders or at different times. Some operations may also be omitted from the process flow 1300, and other operations may be added to the process flow 1300.

In the example of FIG. 13, one or more of the UE 115-k or the network entity 105-i may support activating and deactivating one or more learning models based at least in part on reporting of feedback associated with the one or more learning models by the UE 115-k.

At 1305, the network entity 105-i may transmit, and the UE 115-k may receive, an RRC message that includes a set of one or more RRC configurations, which may include a set of one or more parameters. In some examples, one or more parameters of the set of one or more parameters may include one or more performance KPIs or one or more system KPIs, or a combination thereof. In some other examples, one or more parameters of the set of one or more parameters may include one or more monitoring events (e.g., thresholds, conditions). In other examples, one or more parameters of the set of one or more parameters may include one or more reporting events, reporting periodicity, etc. At 1310, the UE 115-k may transmit, and the network entity 105-i may receive, an RRC configuration complete message.

At 1315, the network entity 105-i may transmit, and the UE 115-k may receive, input data, which may be input for one or more learning models at the UE 115-k. In some examples, the network entity 105-i may transmit, and the UE 115-k may receive, input data via one or more unicast transmissions. In some other examples, the network entity 105-i may broadcast, and the UE 115-k may receive, input data via one or more broadcast transmissions as described herein with reference to FIGS. 3 through 8.

At 1320, the UE 115-k may monitor for one or more events (e.g., threshold satisfied, conditions satisfied) associated with the one or more learning models. At 1325, the UE 115-k may transmit, and the network entity 105-i may receive, a report based at least in part on the one or more events. The report may indicate the one or more performance KPIs or the one or more system KPIs, or a combination thereof.

At 1330-a, one or more of the UE 115-k or the network entity 105-i may switch between one or more learning models as described herein. For example, one or more of the UE 115-k or the network entity 105-i may active at least one learning model of the one or more learning models based at least in part on the reported one or more performance KPIs or the reported one or more system KPIs, or a combination thereof. Additionally, or alternatively, at 1330-b, one or more of the UE 115-k or the network entity 105-i may activate or deactivate at least one learning model of the one or more learning models based at least in part on the reported one or more performance KPIs or the reported one or more system KPIs, or a combination thereof.

Accordingly, one or more of the UE 115-k or the network entity 105-i may support activating and deactivating one or more learning models based at least in part on reported feedback associated with the one or more learning models by the UE 115-k.

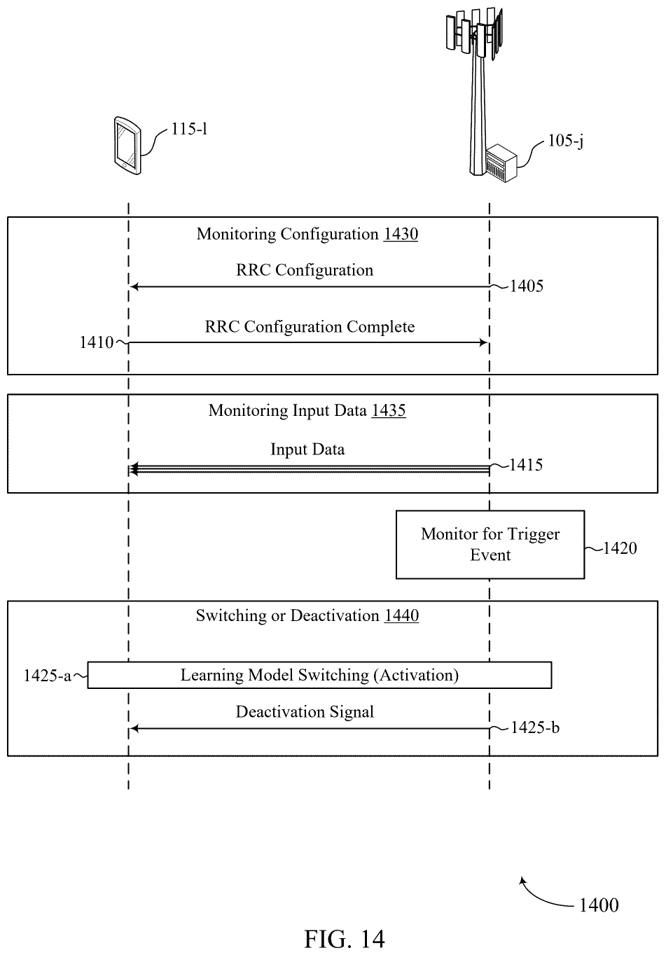

FIG. 14 shows an example of a process flow 1400 that supports discard timer selection in accordance with one or more aspects of the present disclosure. The process flow 1400 may implement aspects of the wireless communications system 100, the wireless communications system 200, the device 300, or a combination thereof, as described with reference to FIGS. 1-3. The process flow 1400 may include a UE 115-1 and a network entity 105-j, which may be examples of UEs 115 and network entities 105 as described herein. In the following description of the process flow 1400, the operations between the UE 115-1 and the network entity 105-j may be transmitted in a different order than the example order shown, or the operations performed by the UE 115-1 and the network entity 105-j may be performed in different orders or at different times. Some operations may also be omitted from the process flow 1400, and other operations may be added to the process flow 1400.

In the example of FIG. 14, one or more of the UE 115-1 or the network entity 105-h may support activating and deactivating one or more learning models based at least in part on monitoring by the network entity 105-j of the one or more learning models.

At 1405, the network entity 105-j may transmit, and the UE 115-1 may receive, an RRC message that includes set of one or more RRC configurations, which may include a set of one or more parameters. In some examples, one or more parameters of the set of one or more parameters may include one or more performance KPIs or one or more system KPIs, or a combination thereof. At 1410, the UE 115-1 may transmit, and the network entity 105-j may receive, an RRC configuration complete message.

At 1415, the network entity 105-h may receive, and the UE 115-1 may transmit, input data, which may be input for one or more learning models at the network entity 105-j. In some examples, the network entity 105-j may receive, and the UE 115-1 may transmit, input data via one or more unicast transmissions. At 1420, the network entity 105-j may monitor for one or more events (e.g., threshold satisfied, conditions satisfied) associated with the one or more learning models at the network entity 105-j.

At 1425-a, one or more of the UE 115-1 or the network entity 105-j may switch between one or more learning models based at least in part on the one or more events as described herein. For example, one or more of the UE 115-1 or the network entity 105-j may active at least one learning model of the one or more learning models based at least in part on the one or more events as described herein. Additionally, or alternatively, at 1425-b, one or more of the UE 115-1 or the network entity 105-j may deactivate at least one learning model of the one or more learning models based at least in part on the one or more events as described herein.

Accordingly, one or more of the UE 115-1 or the network entity 105-j may support activating and deactivating one or more learning models to enable discard timer selection at the UE 115-1 based at least in part on monitoring by the network entity 105-j of the one or more learning models.

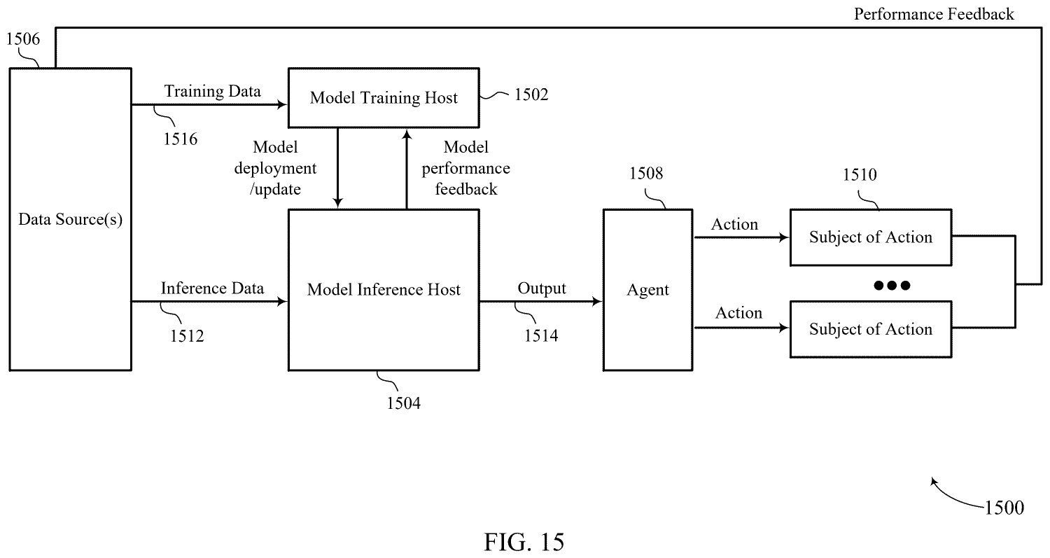

FIG. 15 is an illustrative block diagram of an example ML architecture 1500 that may be used for wireless communications in accordance with one or more aspects of the present disclosure. The ML architecture 1500 may be used for wireless communications in any of the various implementations, processes, environments, networks, or use cases listed above. As illustrated, architecture 1500 includes multiple logical entities, such as model training host 1502, model inference host 1504, data source(s) 1506, and agent 1508. Model inference host 1504 is configured to run an ML model based on inference data 1512 provided by data source(s) 1506. Model inference host 1504 may produce output 1514, which may include a prediction or inference, such as a discrete or continuous value based on inference data 1512, which may then be provided as input to the agent 1508.

Agent 1508 may represent an element or an entity of a wireless communication system including, for example, a radio access network (RAN), a wireless local area network, a device-to-device (D2D) communications system, etc. As an example, agent 1508 may be a UE (e.g., UE 115 as described with reference to FIGS. 1 through 14), a base station (e.g., a base station 140 as described with reference to FIG. 1), or a disaggregated network entity (such as a CU, a DU, or a RU as described with reference to FIG. 1), an access point, a wireless station, a RIC in a cloud-based RAN, among some examples. Additionally, agent 1508 also may be a type of agent that depends on the type of tasks performed by model inference host 1504, the type of inference data 1512 provided to model inference host 1504, or the type of output 1514 produced by model inference host 1504.

Agent 1508 may perform one or more actions associated with receiving output 1514 from model inference host 1504. For example, if agent 1508 is a UE 115 and the output from model inference host 1504 is associated with discard timer selection, the agent 1508 may perform one or more discard timer selection procedures based on output 1514.

Agent 1508 may indicate the one or more actions performed to at least one subject of action 1510. For example, if the agent 1508 performs discard timer selection procedures, the agent 1508 may output an indication to the subject of action 1510 (such as, one or more discard timers of the UE 115).

As another example, agent 1508 may be a UE 115 and output 1514 from model inference host 1504 may include one or more characteristics for selection of discard timer values. For example, model inference host 1504 may predict various parameters for discard timer selection procedures. Based on the predicted parameters, agent 1508 may select various discard timer values and output the discard timer values to the subject of action 1510 (such as, one or more protocol layers of the UE 115 as described with reference to FIG. 2). In some cases, agent 1508 and the subject of action 1510 are the same entity.

Data can be collected from data sources 1506, and may be used as training data 1516 for training an ML model, or as inference data 1512 for feeding an ML model inference operation. Data sources 1506 may collect data from various subject of action 1510 entities (such as, the UE 115 or the network entity 105), and provide the collected data to a model training host 1502 for ML model training. For example, after a subject of action 1510 (such as, a discard timer of the UE 115) obtains a discard timer value from agent 1508, the subject of action 1510 may provide performance feedback associated with the discard timers to the data sources 1506. The performance feedback may be used by the model training host 1502 for monitoring or evaluating the ML model performance. In some examples, if output 1514 provided to agent 1508 is inaccurate (or the accuracy is below an accuracy threshold), model training host 1502 may provide feedback to model inference host 1504 to modify or retrain the ML model used by model inference host 1504, such as via an ML model deployment update.

Model training host 1502 may be deployed at the same or a different entity than that in which model inference host 1504 is deployed. For example, in order to offload model training processing, which can impact the performance of model inference host 1504, model training host 1502 may be deployed at a model server.

In some aspects, an ML model is deployed at or on a network entity (such as a base station 140 or a network entity 105) for supporting discard timer selection. More specifically, a model interference host, such as model inference host 1504 in FIG. 15, may be deployed at or on the network entity 105 for various discard timer selection procedures.

In some other aspects, an ML model is deployed at or on a UE (such as UE 115) for use in discard timer selection procedures. More specifically, a model inference host, such as model inference host 1504 in FIG. 15, may be deployed at or on the UE for discard timer selection procedures.

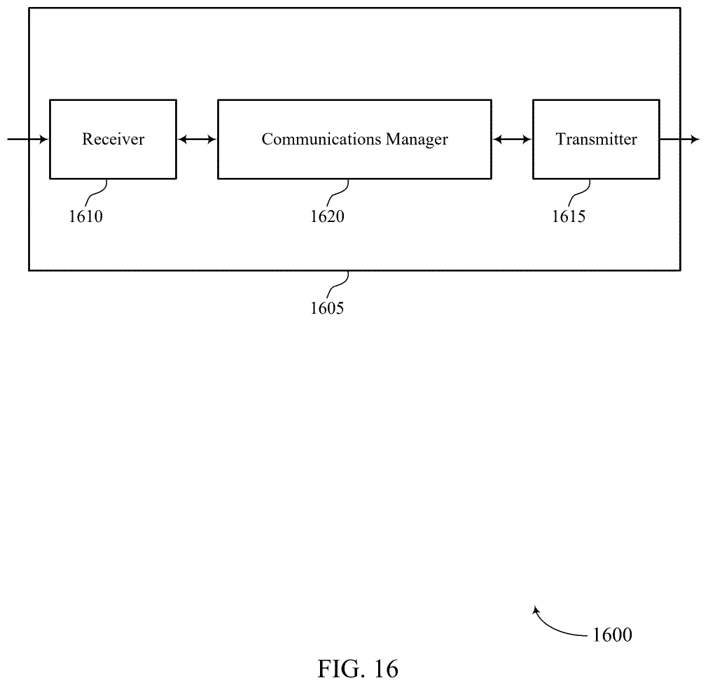

FIG. 16 shows a block diagram 1600 of a device 1605 that supports discard timer selection in accordance with one or more aspects of the present disclosure. The device 1605 may be an example of aspects of a UE 115 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to, individually or collectively, support or enable the described techniques. Each of these components may be in communication with one another (e.g., via one or more buses).

The receiver 1610 may provide a means for receiving information such as packets, user data, control information, or any combination thereof associated with various information channels (e.g., control channels, data channels, information channels related to discard timer selection). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to discard timer selection). In some examples, the transmitter 1615 may be co-located with a receiver 1610 in a transceiver module. The transmitter 1615 may utilize a single antenna or a set of multiple antennas.

The communications manager 1620, the receiver 1610, the transmitter 1615, or various combinations or components thereof may be examples of means for performing various aspects of discard timer selection as described herein. For example, the communications manager 1620, the receiver 1610, the transmitter 1615, or various combinations or components thereof may be capable of performing one or more of the functions described herein.

In some examples, the communications manager 1620, the receiver 1610, the transmitter 1615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1620, the receiver 1610, the transmitter 1615, or various combinations or components thereof may be implemented in code (e.g., as communications management software or firmware) executed by at least one processor (e.g., referred to as a processor-executable code). If implemented in code executed by at least one processor, the functions of the communications manager 1620, the receiver 1610, the transmitter 1615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1620 may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. For example, the communications manager 1620 is capable of, configured to, or operable to support a means for receiving, based on a capability of the UE to perform a discard timer selection procedure for a discard timer associated with a PDCP layer of a protocol stack of the UE, a control message indicating one or more selection parameters for the discard timer selection procedure. The communications manager 1620 is capable of, configured to, or operable to support a means for performing, based on the one or more selection parameters, the discard timer selection procedure to obtain a discard timer value for the discard timer associated with the PDCP layer of the protocol stack of the UE. The communications manager 1620 is capable of, configured to, or operable to support a means for storing, at a buffer associated with the protocol stack of the UE, one or more PDCP SDUs associated with an uplink message for the UE, where the one or more PDCP SDUs are associated with one or more respective discard timers configured in accordance with the discard timer value obtained from the discard timer selection procedure.

By including or configuring the communications manager 1620 in accordance with examples as described herein, the device 1605 (e.g., at least one processor controlling or otherwise coupled with the receiver 1610, the transmitter 1615, the communications manager 1620, or a combination thereof) may support techniques for reduced processing, reduced power consumption, and more efficient utilization of communication resources.

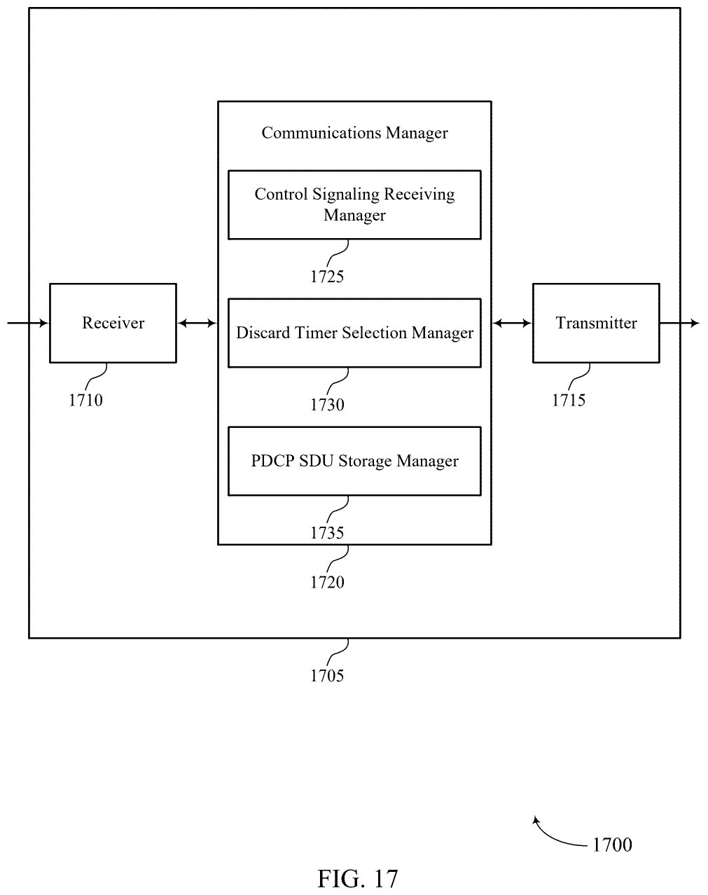

FIG. 17 shows a block diagram 1700 of a device 1705 that supports discard timer selection in accordance with one or more aspects of the present disclosure. The device 1705 may be an example of aspects of a device 1605 or a UE 115 as described herein. The device 1705 may include a receiver 1710, a transmitter 1715, and a communications manager 1720. The device 1705, or one or more components of the device 1705 (e.g., the receiver 1710, the transmitter 1715, the communications manager 1720), may include at least one processor, which may be coupled with at least one memory, to support the described techniques. Each of these components may be in communication with one another (e.g., via one or more buses).

The receiver 1710 may provide a means for receiving information such as packets, user data, control information, or any combination thereof associated with various information channels (e.g., control channels, data channels, information channels related to discard timer selection). Information may be passed on to other components of the device 1705. The receiver 1710 may utilize a single antenna or a set of multiple antennas.

The transmitter 1715 may provide a means for transmitting signals generated by other components of the device 1705. For example, the transmitter 1715 may transmit information such as packets, user data, control information, or any combination thereof associated with various information channels (e.g., control channels, data channels, information channels related to discard timer selection). In some examples, the transmitter 1715 may be co-located with a receiver 1710 in a transceiver module. The transmitter 1715 may utilize a single antenna or a set of multiple antennas.

The device 1705, or various components thereof, may be an example of means for performing various aspects of discard timer selection as described herein. For example, the communications manager 1720 may include a control signaling receiving manager 1725, a discard timer selection manager 1730, a PDCP SDU storage manager 1735, or any combination thereof. The communications manager 1720 may be an example of aspects of a communications manager 1620 as described herein. In some examples, the communications manager 1720, or various components thereof, may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communications in accordance with examples as disclosed herein. The control signaling receiving manager 1725 is capable of, configured to, or operable to support a means for receiving, based on a capability of the UE to perform a discard timer selection procedure for a discard timer associated with a PDCP layer of a protocol stack of the UE, a control message indicating one or more selection parameters for the discard timer selection procedure. The discard timer selection manager 1730 is capable of, configured to, or operable to support a means for performing, based on the one or more selection parameters, the discard timer selection procedure to obtain a discard timer value for the discard timer associated with the PDCP layer of the protocol stack of the UE. The PDCP SDU storage manager 1735 is capable of, configured to, or operable to support a means for storing, at a buffer associated with the protocol stack of the UE, one or more PDCP SDUs associated with an uplink message for the UE, where the one or more PDCP SDUs are associated with one or more respective discard timers configured in accordance with the discard timer value obtained from the discard timer selection procedure.

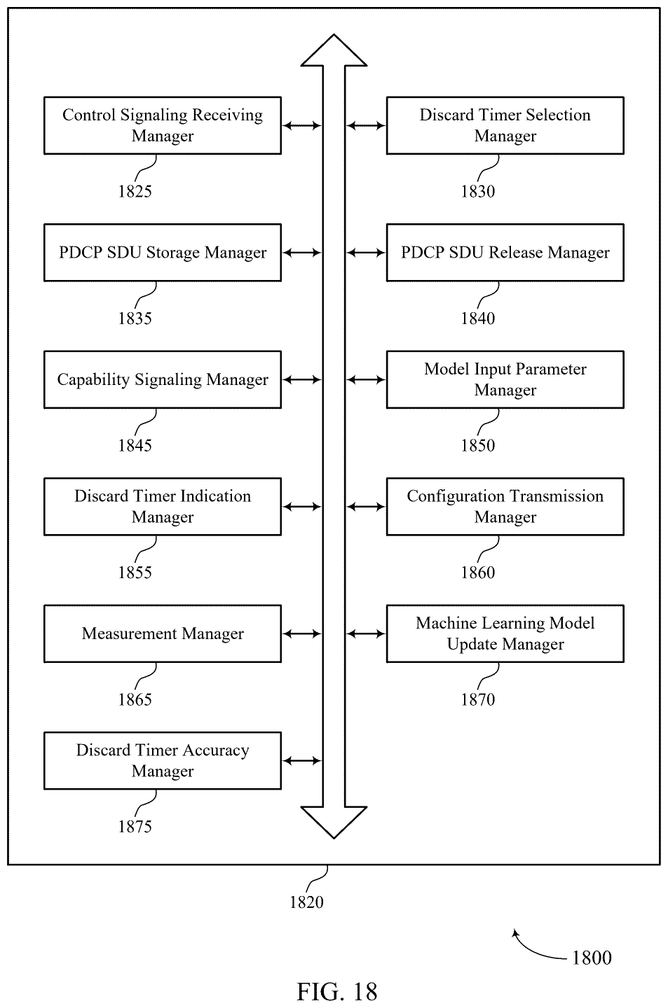

FIG. 18 shows a block diagram 1800 of a communications manager 1820 that supports discard timer selection in accordance with one or more aspects of the present disclosure. The communications manager 1820 may be an example of aspects of a communications manager 1620, a communications manager 1720, or both, as described herein. The communications manager 1820, or various components thereof, may be an example of means for performing various aspects of discard timer selection as described herein. For example, the communications manager 1820 may include a control signaling receiving manager 1825, a discard timer selection manager 1830, a PDCP SDU storage manager 1835, a PDCP SDU release manager 1840, a capability signaling manager 1845, a model input parameter manager 1850, a discard timer indication manager 1855, a configuration transmission manager 1860, a measurement manager 1865, a machine learning model update manager 1870, a discard timer accuracy manager 1875, or any combination thereof. Each of these components, or components or subcomponents thereof (e.g., one or more processors, one or more memories), may communicate, directly or indirectly, with one another (e.g., via one or more buses).

The communications manager 1820 may support wireless communications in accordance with examples as disclosed herein. The control signaling receiving manager 1825 is capable of, configured to, or operable to support a means for receiving, based on a capability of the UE to perform a discard timer selection procedure for a discard timer associated with a PDCP layer of a protocol stack of the UE, a control message indicating one or more selection parameters for the discard timer selection procedure. The discard timer selection manager 1830 is capable of, configured to, or operable to support a means for performing, based on the one or more selection parameters, the discard timer selection procedure to obtain a discard timer value for the discard timer associated with the PDCP layer of the protocol stack of the UE. The PDCP SDU storage manager 1835 is capable of, configured to, or operable to support a means for storing, at a buffer associated with the protocol stack of the UE, one or more PDCP SDUs associated with an uplink message for the UE, where the one or more PDCP SDUs are associated with one or more respective discard timers configured in accordance with the discard timer value obtained from the discard timer selection procedure.

In some examples, the PDCP SDU release manager 1840 is capable of, configured to, or operable to support a means for performing, based on storing the one or more PDCP SDUs at the buffer, an SDU release procedure by dropping a PDCP SDU of the one or more PDCP SDUs from the buffer based on expiration of a respective discard timer for the PDCP SDU, the one or more respective discard timers including the respective discard timer for the PDCP SDU.

In some examples, the measurement manager 1865 is capable of, configured to, or operable to support a means for performing, based on performing the SDU release procedure, one or more discard timer characteristic measurement procedures to obtain data associated with the discard timer associated with the PDCP SDU of the one or more PDCP SDUs. In some examples, the machine learning model update manager 1870 is capable of, configured to, or operable to support a means for performing, based on performing the one or more discard timer characteristic measurement procedures, an update procedure to update a machine learning model of the UE according to the data. In some examples, the discard timer selection manager 1830 is capable of, configured to, or operable to support a means for performing, based on performing the update procedure, a second discard timer selection procedure to obtain an updated discard timer value for the discard timer using the updated machine learning model.

In some examples, the discard timer accuracy manager 1875 is capable of, configured to, or operable to support a means for performing, based on performing the second discard timer selection procedure, an accuracy monitoring procedure to determine whether the updated discard timer value satisfies one or more key performance indicators.

In some examples, the capability signaling manager 1845 is capable of, configured to, or operable to support a means for transmitting a capability message indicating the capability of the UE to perform the discard timer selection procedure for the discard timer associated with the PDCP layer of the protocol stack of the UE, the capability of the UE associated with a source cell, a target cell, or both, and is based on a buffer allocation value or buffer utilization threshold value, where the control message is received in response to the capability message.

In some examples, to support performing the discard timer selection procedure, the model input parameter manager 1850 is capable of, configured to, or operable to support a means for inputting one or more model input parameters into a machine learning model, where the one or more model input parameters include one or more radio conditions, one or more performance target parameters, one or more wireless communication traffic conditions, or a combination thereof. In some examples, to support performing the discard timer selection procedure, the discard timer selection manager 1830 is capable of, configured to, or operable to support a means for obtaining, after inputting the one or more model input parameters, the discard timer value for the discard timer from an output of the machine learning model for the discard timer selection procedure.

In some examples, the discard timer indication manager 1855 is capable of, configured to, or operable to support a means for transmitting, after performance of the discard timer selection procedure, an indication of the discard timer value for the discard timer, where the discard timer value is for a single cell or for handover to a target cell.

In some examples, to support performing the discard timer selection procedure, the discard timer selection manager 1830 is capable of, configured to, or operable to support a means for obtaining the discard timer value using a machine learning model that is based on the buffer utilization threshold value.

In some examples, the configuration transmission manager 1860 is capable of, configured to, or operable to support a means for receiving a configuration message indicating one or more model input parameters, where the one or more model input parameters include a maximum discard timer value, a minimum discard timer value, a maximum packet discard rate, or a combination thereof. In some examples, the model input parameter manager 1850 is capable of, configured to, or operable to support a means for inputting the one or more model input parameters into a machine learning model. In some examples, the discard timer selection manager 1830 is capable of, configured to, or operable to support a means for obtaining, after inputting the one or more model input parameters, the discard timer value for the discard timer from an output of the machine learning model for the discard timer selection procedure.

In some examples, to support performing the discard timer selection procedure, the discard timer selection manager 1830 is capable of, configured to, or operable to support a means for obtaining one or more discard timer values using a machine learning model that is based on the QoS value, the logical channel, the CC, and the cell group, or the combination thereof.

In some examples, the configuration transmission manager 1860 is capable of, configured to, or operable to support a means for receiving a configuration indicating one or more model input parameters, where the one or more model input parameters include an identifier for one or more cells associated with a network entity, one or more cell measurement configurations, or a combination thereof. In some examples, the model input parameter manager 1850 is capable of, configured to, or operable to support a means for inputting the one or more model input parameters into a machine learning model. In some examples, the discard timer selection manager 1830 is capable of, configured to, or operable to support a means for obtaining, after inputting the one or more model input parameters, the discard timer value for the discard timer from an output of the machine learning model for the discard timer selection procedure.

In some examples, to support performing the discard timer selection procedure, the discard timer selection manager 1830 is capable of, configured to, or operable to support a means for obtaining the discard timer value using a machine learning model that is based on the key performance indicator violation report, the over-discarding indication, and the latency value, or the combination thereof.

In some examples, the discard timer selection manager 1830 is capable of, configured to, or operable to support a means for performing the discard timer selection procedure to obtain the discard timer value, where the discard timer value fails to satisfy one or more performance targets. In some examples, the discard timer selection manager 1830 is capable of, configured to, or operable to support a means for selecting, based on the discard timer value failing to satisfy the one or more performance targets, a second discard timer value for the discard timer according to a fallback procedure associated with the PDCP layer of the protocol stack of the UE.

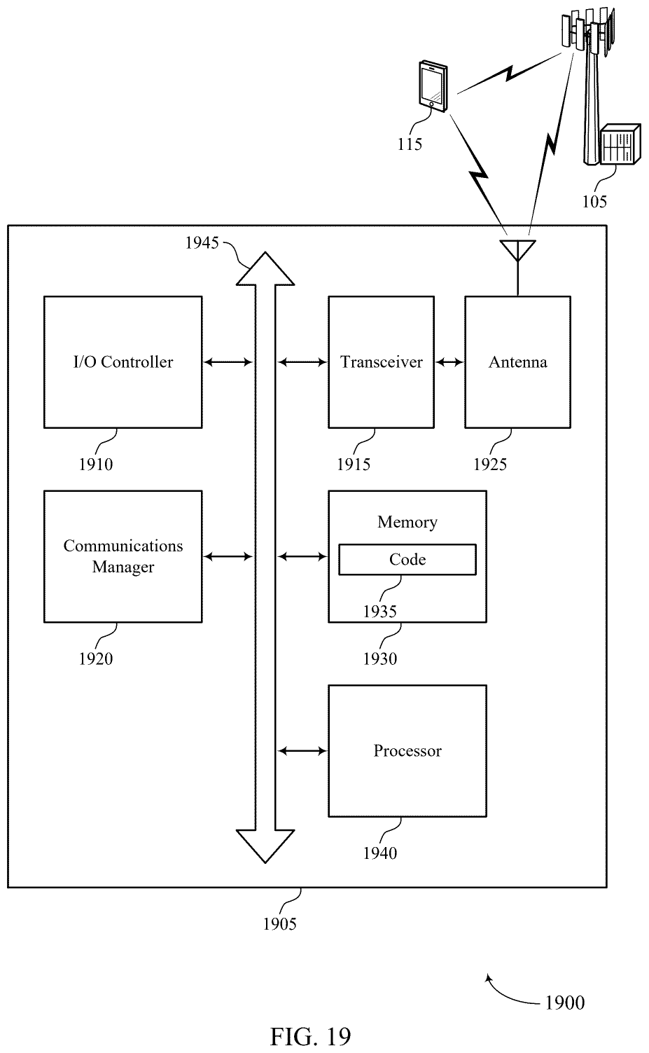

FIG. 19 shows a diagram of a system 1900 including a device 1905 that supports discard timer selection in accordance with one or more aspects of the present disclosure. The device 1905 may be an example of or include components of a device 1605, a device 1705, or a UE 115 as described herein. The device 1905 may communicate (e.g., wirelessly) with one or more other devices (e.g., network entities 105, UEs 115, or a combination thereof). The device 1905 may include components for bi-directional voice and data communications including components for transmitting and receiving communications, such as a communications manager 1920, an input/output (I/O) controller, such as an I/O controller 1910, a transceiver 1915, one or more antennas 1925, at least one memory 1930, code 1935, and at least one processor 1940. These components may be in electronic communication or otherwise coupled (e.g., operatively, communicatively, functionally, electronically, electrically) via one or more buses (e.g., a bus 1945).

The I/O controller 1910 may manage input and output signals for the device 1905. The I/O controller 1910 may also manage peripherals not integrated into the device 1905. In some cases, the I/O controller 1910 may represent a physical connection or port to an external peripheral. In some cases, the I/O controller 1910 may utilize an operating system such as iOS®, ANDROID®, MS-DOS®, MS-WINDOWS®, OS/2®, UNIX®, LINUX®, or another known operating system. Additionally, or alternatively, the I/O controller 1910 may represent or interact with a modem, a keyboard, a mouse, a touchscreen, or a similar device. In some cases, the I/O controller 1910 may be implemented as part of one or more processors, such as the at least one processor 1940. In some cases, a user may interact with the device 1905 via the I/O controller 1910 or via hardware components controlled by the I/O controller 1910.

In some cases, the device 1905 may include a single antenna. However, in some other cases, the device 1905 may have more than one antenna, which may be capable of concurrently transmitting or receiving multiple wireless transmissions. The transceiver 1915 may communicate bi-directionally via the one or more antennas 1925 using wired or wireless links as described herein. For example, the transceiver 1915 may represent a wireless transceiver and may communicate bi-directionally with another wireless transceiver. The transceiver 1915 may also include a modem to modulate the packets, to provide the modulated packets to one or more antennas 1925 for transmission, and to demodulate packets received from the one or more antennas 1925. The transceiver 1915, or the transceiver 1915 and one or more antennas 1925, may be an example of a transmitter 1615, a transmitter 1715, a receiver 1610, a receiver 1710, or any combination thereof or component thereof, as described herein.

The at least one memory 1930 may include random access memory (RAM) and read-only memory (ROM). The at least one memory 1930 may store computer-readable, computer-executable, or processor-executable code, such as the code 1935. The code 1935 may include instructions that, when executed by the at least one processor 1940, cause the device 1905 to perform various functions described herein. The code 1935 may be stored in a non-transitory computer-readable medium such as system memory or another type of memory. In some cases, the code 1935 may not be directly executable by the at least one processor 1940 but may cause a computer (e.g., when compiled and executed) to perform functions described herein. In some cases, the at least one memory 1930 may include, among other things, a basic I/O system (BIOS) which may control basic hardware or software operation such as the interaction with peripheral components or devices.

The at least one processor 1940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1940 may be configured to operate a memory array using a memory controller. In some other cases, a memory controller may be integrated into the at least one processor 1940. The at least one processor 1940 may be configured to execute computer-readable instructions stored in a memory (e.g., the at least one memory 1930) to cause the device 1905 to perform various functions (e.g., functions or tasks supporting discard timer selection). For example, the device 1905 or a component of the device 1905 may include at least one processor 1940 and at least one memory 1930 coupled with or to the at least one processor 1940, the at least one processor 1940 and the at least one memory 1930 configured to perform various functions described herein.

In some examples, the at least one processor 1940 may include multiple processors and the at least one memory 1930 may include multiple memories. One or more of the multiple processors may be coupled with one or more of the multiple memories, which may, individually or collectively, be configured to perform various functions described herein. In some examples, the at least one processor 1940 may be a component of a processing system, which may refer to a system (such as a series) of machines, circuitry (including, for example, one or both of processor circuitry (which may include the at least one processor 1940) and memory circuitry (which may include the at least one memory 1930)), or components, that receives or obtains inputs and processes the inputs to produce, generate, or obtain a set of outputs. The processing system may be configured to perform one or more of the functions described herein. For example, the at least one processor 1940 or a processing system including the at least one processor 1940 may be configured to, configurable to, or operable to cause the device 1905 to perform one or more of the functions described herein. Further, as described herein, being “configured to,” being “configurable to,” and being “operable to” may be used interchangeably and may be associated with a capability, when executing code 1935 (e.g., processor-executable code) stored in the at least one memory 1930 or otherwise, to perform one or more of the functions described herein.

The communications manager 1920 may support wireless communications in accordance with examples as disclosed herein. For example, the communications manager 1920 is capable of, configured to, or operable to support a means for receiving, based on a capability of the UE to perform a discard timer selection procedure for a discard timer associated with a PDCP layer of a protocol stack of the UE, a control message indicating one or more selection parameters for the discard timer selection procedure. The communications manager 1920 is capable of, configured to, or operable to support a means for performing, based on the one or more selection parameters, the discard timer selection procedure to obtain a discard timer value for the discard timer associated with the PDCP layer of the protocol stack of the UE. The communications manager 1920 is capable of, configured to, or operable to support a means for storing, at a buffer associated with the protocol stack of the UE, one or more PDCP SDUs associated with an uplink message for the UE, where the one or more PDCP SDUs are associated with one or more respective discard timers configured in accordance with the discard timer value obtained from the discard timer selection procedure.

By including or configuring the communications manager 1920 in accordance with examples as described herein, the device 1905 may support techniques for improved communication reliability, reduced latency, improved user experience related to reduced processing, more efficient utilization of communication resources, improved coordination between devices, and improved utilization of processing capability.

In some examples, the communications manager 1920 may be configured to perform various operations (e.g., receiving, monitoring, transmitting) using or otherwise in cooperation with the transceiver 1915, the one or more antennas 1925, or any combination thereof. Although the communications manager 1920 is illustrated as a separate component, in some examples, one or more functions described with reference to the communications manager 1920 may be supported by or performed by the at least one processor 1940, the at least one memory 1930, the code 1935, or any combination thereof. For example, the code 1935 may include instructions executable by the at least one processor 1940 to cause the device 1905 to perform various aspects of discard timer selection as described herein, or the at least one processor 1940 and the at least one memory 1930 may be otherwise configured to, individually or collectively, perform or support such operations.

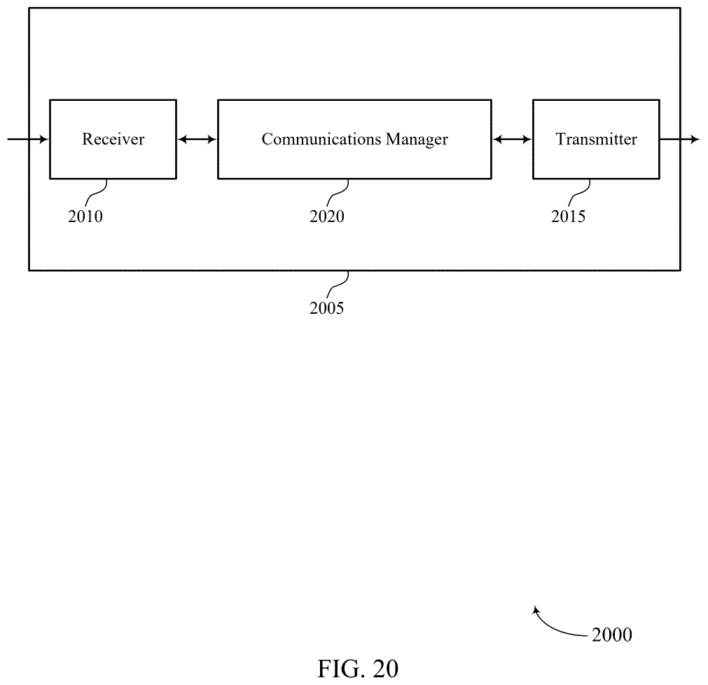

FIG. 20 shows a block diagram 2000 of a device 2005 that supports discard timer selection in accordance with one or more aspects of the present disclosure. The device 2005 may be an example of aspects of a network entity 105 as described herein. The device 2005 may include a receiver 2010, a transmitter 2015, and a communications manager 2020. The device 2005, or one or more components of the device 2005 (e.g., the receiver 2010, the transmitter 2015, the communications manager 2020), may include at least one processor, which may be coupled with at least one memory, to, individually or collectively, support or enable the described techniques. Each of these components may be in communication with one another (e.g., via one or more buses).

The receiver 2010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 2005. In some examples, the receiver 2010 may support obtaining information by receiving signals via one or more antennas. Additionally, or alternatively, the receiver 2010 may support obtaining information by receiving signals via one or more wired (e.g., electrical, fiber optic) interfaces, wireless interfaces, or any combination thereof.

The transmitter 2015 may provide a means for outputting (e.g., transmitting, providing, conveying, sending) information generated by other components of the device 2005. For example, the transmitter 2015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 2015 may support outputting information by transmitting signals via one or more antennas. Additionally, or alternatively, the transmitter 2015 may support outputting information by transmitting signals via one or more wired (e.g., electrical, fiber optic) interfaces, wireless interfaces, or any combination thereof. In some examples, the transmitter 2015 and the receiver 2010 may be co-located in a transceiver, which may include or be coupled with a modem.

The communications manager 2020, the receiver 2010, the transmitter 2015, or various combinations or components thereof may be examples of means for performing various aspects of discard timer selection as described herein. For example, the communications manager 2020, the receiver 2010, the transmitter 2015, or various combinations or components thereof may be capable of performing one or more of the functions described herein.

In some examples, the communications manager 2020, the receiver 2010, the transmitter 2015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 2020, the receiver 2010, the transmitter 2015, or various combinations or components thereof may be implemented in code (e.g., as communications management software or firmware) executed by at least one processor (e.g., referred to as a processor-executable code). If implemented in code executed by at least one processor, the functions of the communications manager 2020, the receiver 2010, the transmitter 2015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 2020 may be configured to perform various operations (e.g., receiving, obtaining, monitoring, outputting, transmitting) using or otherwise in cooperation with the receiver 2010, the transmitter 2015, or both. For example, the communications manager 2020 may receive information from the receiver 2010, send information to the transmitter 2015, or be integrated in combination with the receiver 2010, the transmitter 2015, or both to obtain information, output information, or perform various other operations as described herein.

The communications manager 2020 may support wireless communications in accordance with examples as disclosed herein. For example, the communications manager 2020 is capable of, configured to, or operable to support a means for obtaining a capability message indicating a capability of a UE to perform a discard timer selection procedure for a discard timer associated with a PDCP layer of a protocol stack of the UE. The communications manager 2020 is capable of, configured to, or operable to support a means for performing, based on the capability message, a selection parameter selection procedure to obtain one or more selection parameters for the discard timer selection procedure of the UE. The communications manager 2020 is capable of, configured to, or operable to support a means for outputting, based on performing the selection parameter selection procedure, a control message indicating the one or more selection parameters.

By including or configuring the communications manager 2020 in accordance with examples as described herein, the device 2005 (e.g., at least one processor controlling or otherwise coupled with the receiver 2010, the transmitter 2015, the communications manager 2020, or a combination thereof) may support techniques for reduced processing, reduced power consumption, and more efficient utilization of communication resources.

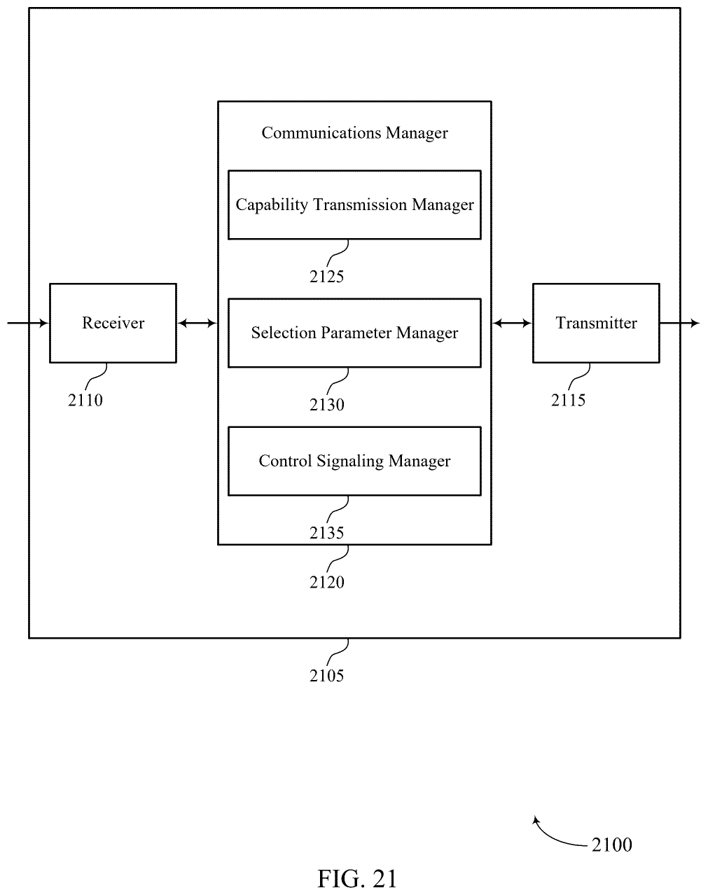

FIG. 21 shows a block diagram 2100 of a device 2105 that supports discard timer selection in accordance with one or more aspects of the present disclosure. The device 2105 may be an example of aspects of a device 2005 or a network entity 105 as described herein. The device 2105 may include a receiver 2110, a transmitter 2115, and a communications manager 2120. The device 2105, or one or more components of the device 2105 (e.g., the receiver 2110, the transmitter 2115, the communications manager 2120), may include at least one processor, which may be coupled with at least one memory, to support the described techniques. Each of these components may be in communication with one another (e.g., via one or more buses).

The receiver 2110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 2105. In some examples, the receiver 2110 may support obtaining information by receiving signals via one or more antennas. Additionally, or alternatively, the receiver 2110 may support obtaining information by receiving signals via one or more wired (e.g., electrical, fiber optic) interfaces, wireless interfaces, or any combination thereof.

The transmitter 2115 may provide a means for outputting (e.g., transmitting, providing, conveying, sending) information generated by other components of the device 2105. For example, the transmitter 2115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 2115 may support outputting information by transmitting signals via one or more antennas. Additionally, or alternatively, the transmitter 2115 may support outputting information by transmitting signals via one or more wired (e.g., electrical, fiber optic) interfaces, wireless interfaces, or any combination thereof. In some examples, the transmitter 2115 and the receiver 2110 may be co-located in a transceiver, which may include or be coupled with a modem.

The device 2105, or various components thereof, may be an example of means for performing various aspects of discard timer selection as described herein. For example, the communications manager 2120 may include a capability transmission manager 2125, a selection parameter manager 2130, a control signaling manager 2135, or any combination thereof. The communications manager 2120 may be an example of aspects of a communications manager 2020 as described herein. In some examples, the communications manager 2120, or various components thereof, may be configured to perform various operations (e.g., receiving, obtaining, monitoring, outputting, transmitting) using or otherwise in cooperation with the receiver 2110, the transmitter 2115, or both. For example, the communications manager 2120 may receive information from the receiver 2110, send information to the transmitter 2115, or be integrated in combination with the receiver 2110, the transmitter 2115, or both to obtain information, output information, or perform various other operations as described herein.

The communications manager 2120 may support wireless communications in accordance with examples as disclosed herein. The capability transmission manager 2125 is capable of, configured to, or operable to support a means for obtaining a capability message indicating a capability of a UE to perform a discard timer selection procedure for a discard timer associated with a PDCP layer of a protocol stack of the UE. The selection parameter manager 2130 is capable of, configured to, or operable to support a means for performing, based on the capability message, a selection parameter selection procedure to obtain one or more selection parameters for the discard timer selection procedure of the UE. The control signaling manager 2135 is capable of, configured to, or operable to support a means for outputting, based on performing the selection parameter selection procedure, a control message indicating the one or more selection parameters.

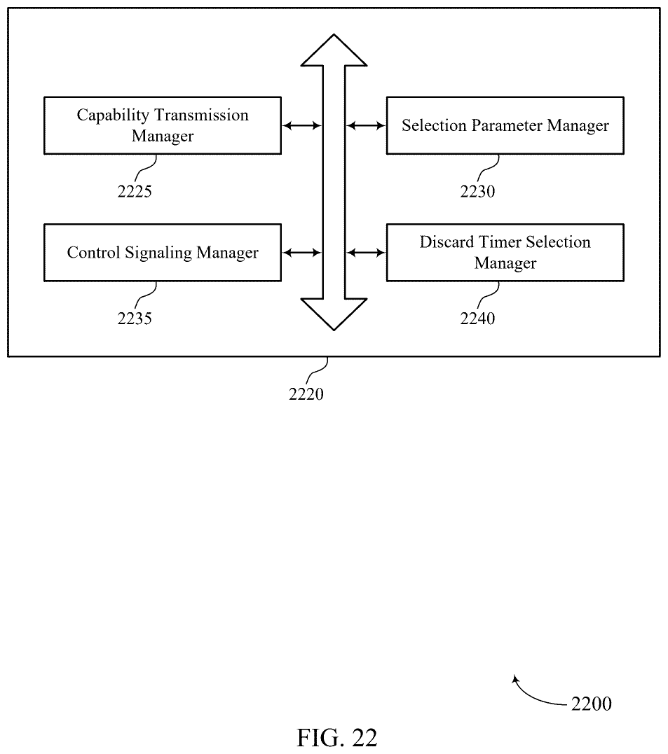

FIG. 22 shows a block diagram 2200 of a communications manager 2220 that supports discard timer selection in accordance with one or more aspects of the present disclosure. The communications manager 2220 may be an example of aspects of a communications manager 2020, a communications manager 2120, or both, as described herein. The communications manager 2220, or various components thereof, may be an example of means for performing various aspects of discard timer selection as described herein. For example, the communications manager 2220 may include a capability transmission manager 2225, a selection parameter manager 2230, a control signaling manager 2235, a discard timer selection manager 2240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 2220 may support wireless communications in accordance with examples as disclosed herein. The capability transmission manager 2225 is capable of, configured to, or operable to support a means for obtaining a capability message indicating a capability of a UE to perform a discard timer selection procedure for a discard timer associated with a PDCP layer of a protocol stack of the UE. The selection parameter manager 2230 is capable of, configured to, or operable to support a means for performing, based on the capability message, a selection parameter selection procedure to obtain one or more selection parameters for the discard timer selection procedure of the UE. The control signaling manager 2235 is capable of, configured to, or operable to support a means for outputting, based on performing the selection parameter selection procedure, a control message indicating the one or more selection parameters.

In some examples, the discard timer selection manager 2240 is capable of, configured to, or operable to support a means for obtaining, after outputting the control message, an indication of a discard timer value for the discard timer, where the discard timer value is for a single cell or for handover to a target cell.

In some examples, the one or more selection parameters include a buffer utilization threshold value.

In some examples, the one or more selection parameters include a quality of service (QOS) value, a logical channel, a component carrier (CC), and a cell group, or a combination thereof.

In some examples, the one or more selection parameters include an identifier for one or more cells associated with the network entity.

In some examples, the one or more selection parameters include a key performance indicator violation report, an over-discarding indication, and a latency value, or a combination thereof.

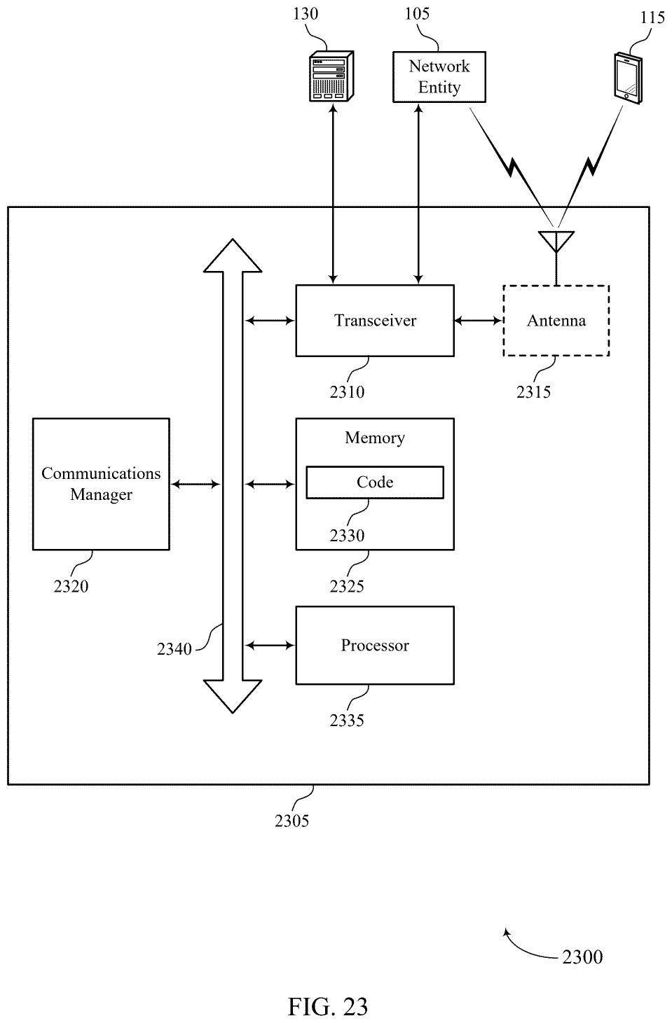

FIG. 23 shows a diagram of a system 2300 including a device 2305 that supports discard timer selection in accordance with one or more aspects of the present disclosure. The device 2305 may be an example of or include components of a device 2005, a device 2105, or a network entity 105 as described herein. The device 2305 may communicate with other network devices or network equipment such as one or more of the network entities 105, UEs 115, or any combination thereof. The communications may include communications over one or more wired interfaces, over one or more wireless interfaces, or any combination thereof. The device 2305 may include components that support outputting and obtaining communications, such as a communications manager 2320, a transceiver 2310, one or more antennas 2315, at least one memory 2325, code 2330, and at least one processor 2335. These components may be in electronic communication or otherwise coupled (e.g., operatively, communicatively, functionally, electronically, electrically) via one or more buses (e.g., a bus 2340).

The transceiver 2310 may support bi-directional communications via wired links, wireless links, or both as described herein. In some examples, the transceiver 2310 may include a wired transceiver and may communicate bi-directionally with another wired transceiver. Additionally, or alternatively, in some examples, the transceiver 2310 may include a wireless transceiver and may communicate bi-directionally with another wireless transceiver. In some examples, the device 2305 may include one or more antennas 2315, which may be capable of transmitting or receiving wireless transmissions (e.g., concurrently). The transceiver 2310 may also include a modem to modulate signals, to provide the modulated signals for transmission (e.g., by one or more antennas 2315, by a wired transmitter), to receive modulated signals (e.g., from one or more antennas 2315, from a wired receiver), and to demodulate signals. In some implementations, the transceiver 2310 may include one or more interfaces, such as one or more interfaces coupled with the one or more antennas 2315 that are configured to support various receiving or obtaining operations, or one or more interfaces coupled with the one or more antennas 2315 that are configured to support various transmitting or outputting operations, or a combination thereof. In some implementations, the transceiver 2310 may include or be configured for coupling with one or more processors or one or more memory components that are operable to perform or support operations based on received or obtained information or signals, or to generate information or other signals for transmission or other outputting, or any combination thereof. In some implementations, the transceiver 2310, or the transceiver 2310 and the one or more antennas 2315, or the transceiver 2310 and the one or more antennas 2315 and one or more processors or one or more memory components (e.g., the at least one processor 2335, the at least one memory 2325, or both), may be included in a chip or chip assembly that is installed in the device 2305. In some examples, the transceiver 2310 may be operable to support communications via one or more communications links (e.g., communication link(s) 125, backhaul communication link(s) 120, a midhaul communication link 162, a fronthaul communication link 168).

The at least one memory 2325 may include RAM, ROM, or any combination thereof. The at least one memory 2325 may store computer-readable, computer-executable, or processor-executable code, such as the code 2330. The code 2330 may include instructions that, when executed by one or more of the at least one processor 2335, cause the device 2305 to perform various functions described herein. The code 2330 may be stored in a non-transitory computer-readable medium such as system memory or another type of memory. In some cases, the code 2330 may not be directly executable by a processor of the at least one processor 2335 but may cause a computer (e.g., when compiled and executed) to perform functions described herein. In some cases, the at least one memory 2325 may include, among other things, a BIOS which may control basic hardware or software operation such as the interaction with peripheral components or devices. In some examples, the at least one processor 2335 may include multiple processors and the at least one memory 2325 may include multiple memories. One or more of the multiple processors may be coupled with one or more of the multiple memories which may, individually or collectively, be configured to perform various functions herein (for example, as part of a processing system).

The at least one processor 2335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 2335 may be configured to operate a memory array using a memory controller. In some other cases, a memory controller may be integrated into one or more of the at least one processor 2335. The at least one processor 2335 may be configured to execute computer-readable instructions stored in a memory (e.g., one or more of the at least one memory 2325) to cause the device 2305 to perform various functions (e.g., functions or tasks supporting discard timer selection). For example, the device 2305 or a component of the device 2305 may include at least one processor 2335 and at least one memory 2325 coupled with one or more of the at least one processor 2335, the at least one processor 2335 and the at least one memory 2325 configured to perform various functions described herein. The at least one processor 2335 may be an example of a cloud-computing platform (e.g., one or more physical nodes and supporting software such as operating systems, virtual machines, or container instances) that may host the functions (e.g., by executing code 2330) to perform the functions of the device 2305. The at least one processor 2335 may be any one or more suitable processors capable of executing scripts or instructions of one or more software programs stored in the device 2305 (such as within one or more of the at least one memory 2325).

In some examples, the at least one processor 2335 may include multiple processors and the at least one memory 2325 may include multiple memories. One or more of the multiple processors may be coupled with one or more of the multiple memories, which may, individually or collectively, be configured to perform various functions herein. In some examples, the at least one processor 2335 may be a component of a processing system, which may refer to a system (such as a series) of machines, circuitry (including, for example, one or both of processor circuitry (which may include the at least one processor 2335) and memory circuitry (which may include the at least one memory 2325)), or components, that receives or obtains inputs and processes the inputs to produce, generate, or obtain a set of outputs. The processing system may be configured to perform one or more of the functions described herein. For example, the at least one processor 2335 or a processing system including the at least one processor 2335 may be configured to, configurable to, or operable to cause the device 2305 to perform one or more of the functions described herein. Further, as described herein, being “configured to,” being “configurable to,” and being “operable to” may be used interchangeably and may be associated with a capability, when executing code stored in the at least one memory 2325 or otherwise, to perform one or more of the functions described herein.

In some examples, a bus 2340 may support communications of (e.g., within) a protocol layer of a protocol stack. In some examples, a bus 2340 may support communications associated with a logical channel of a protocol stack (e.g., between protocol layers of a protocol stack), which may include communications performed within a component of the device 2305, or between different components of the device 2305 that may be co-located or located in different locations (e.g., where the device 2305 may refer to a system in which one or more of the communications manager 2320, the transceiver 2310, the at least one memory 2325, the code 2330, and the at least one processor 2335 may be located in one of the different components or divided between different components).

In some examples, the communications manager 2320 may manage aspects of communications with a core network 130 (e.g., via one or more wired or wireless backhaul links). For example, the communications manager 2320 may manage the transfer of data communications for client devices, such as one or more UEs 115. In some examples, the communications manager 2320 may manage communications with one or more other network entities 105, and may include a controller or scheduler for controlling communications with UEs 115 (e.g., in cooperation with the one or more other network devices). In some examples, the communications manager 2320 may support an X2 interface within an LTE/LTE-A wireless communications network technology to provide communication between network entities 105.

The communications manager 2320 may support wireless communications in accordance with examples as disclosed herein. For example, the communications manager 2320 is capable of, configured to, or operable to support a means for obtaining a capability message indicating a capability of a UE to perform a discard timer selection procedure for a discard timer associated with a PDCP layer of a protocol stack of the UE. The communications manager 2320 is capable of, configured to, or operable to support a means for performing, based on the capability message, a selection parameter selection procedure to obtain one or more selection parameters for the discard timer selection procedure of the UE. The communications manager 2320 is capable of, configured to, or operable to support a means for outputting, based on performing the selection parameter selection procedure, a control message indicating the one or more selection parameters.

By including or configuring the communications manager 2320 in accordance with examples as described herein, the device 2305 may support techniques for improved communication reliability, reduced latency, improved user experience related to reduced processing, more efficient utilization of communication resources, improved coordination between devices, and improved utilization of processing capability.

In some examples, the communications manager 2320 may be configured to perform various operations (e.g., receiving, obtaining, monitoring, outputting, transmitting) using or otherwise in cooperation with the transceiver 2310, the one or more antennas 2315 (e.g., where applicable), or any combination thereof. Although the communications manager 2320 is illustrated as a separate component, in some examples, one or more functions described with reference to the communications manager 2320 may be supported by or performed by the transceiver 2310, one or more of the at least one processor 2335, one or more of the at least one memory 2325, the code 2330, or any combination thereof (for example, by a processing system including at least a portion of the at least one processor 2335, the at least one memory 2325, the code 2330, or any combination thereof). For example, the code 2330 may include instructions executable by one or more of the at least one processor 2335 to cause the device 2305 to perform various aspects of discard timer selection as described herein, or the at least one processor 2335 and the at least one memory 2325 may be otherwise configured to, individually or collectively, perform or support such operations.

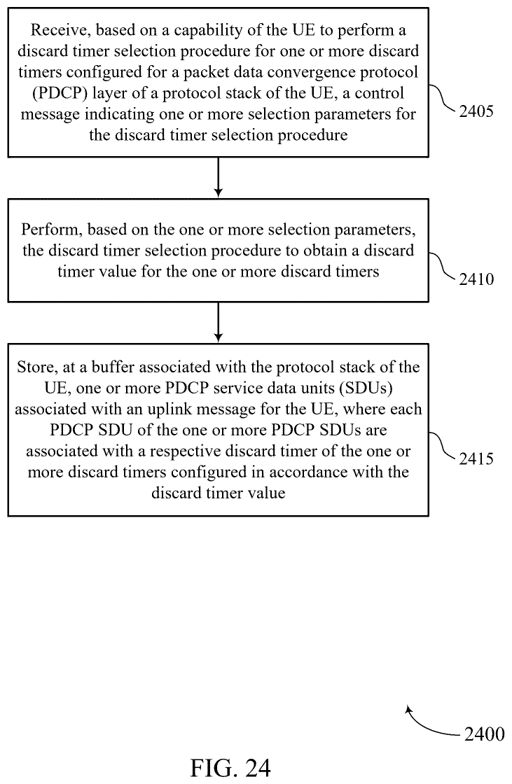

FIG. 24 shows a flowchart illustrating a method 2400 that supports discard timer selection in accordance with one or more aspects of the present disclosure. The operations of the method 2400 may be implemented by a UE or its components as described herein. For example, the operations of the method 2400 may be performed by a UE 115 as described with reference to FIGS. 1 through 19. In some examples, a UE may execute a set of instructions to control the functional elements of the UE to perform the described functions. Additionally, or alternatively, the UE may perform aspects of the described functions using special-purpose hardware.

At 2405, the method may include receiving, based on a capability of the UE (e.g., a UE 115, UE 115-a, a discard timer manager 245, a UE 115-b, a UE 115-c) to perform a discard timer selection procedure for one or more discard timers (e.g., a discard timer 225) configured for a PDCP layer of a protocol stack (e.g., a protocol stack 205) of the UE, a control message indicating one or more selection parameters for the discard timer selection procedure. The operations of 2405 may be performed in accordance with examples as disclosed herein. In some examples, aspects of the operations of 2405 may be performed by a control signaling receiving manager 1825 as described with reference to FIG. 18.

At 2410, the method may include performing, based on the one or more selection parameters, the discard timer selection procedure to obtain a discard timer value for the one or more discard timers. The operations of 2410 may be performed in accordance with examples as disclosed herein. In some examples, aspects of the operations of 2410 may be performed by a discard timer selection manager 1830 (e.g., a discard timer manager 245) as described with reference to FIG. 18.

At 2415, the method may include storing, at a buffer (e.g., a buffer 250, a buffer 250-a) associated with the protocol stack of the UE, one or more PDCP SDUs (e.g., an SDU 275, an SDU 305) associated with an uplink message for the UE, where each PDCP SDU of the one or more PDCP SDUs are associated with a respective discard timer of the one or more discard timers (e.g., the set of discard timers 310) configured in accordance with the discard timer value. The operations of 2415 may be performed in accordance with examples as disclosed herein. In some examples, aspects of the operations of 2415 may be performed by a PDCP SDU storage manager 1835 as described with reference to FIG. 18.

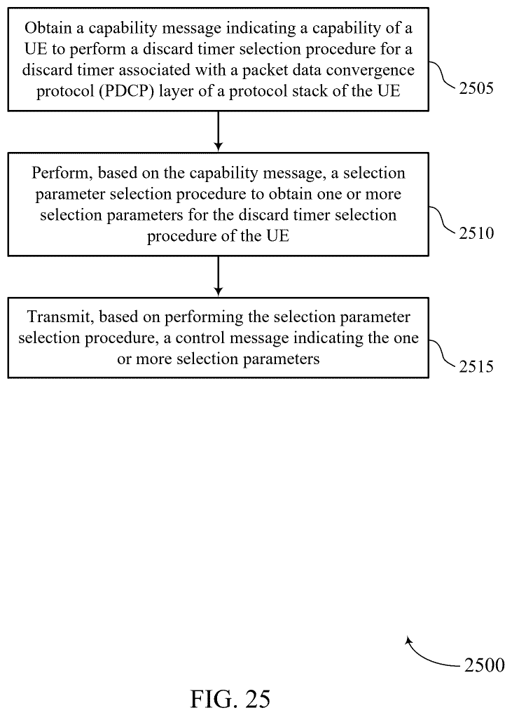

FIG. 25 shows a flowchart illustrating a method 2500 that supports discard timer selection in accordance with one or more aspects of the present disclosure. The operations of the method 2500 may be implemented by a network entity or its components as described herein. For example, the operations of the method 2500 may be performed by a network entity as described with reference to FIGS. 1 through 13 and 20 through 23. In some examples, a network entity may execute a set of instructions to control the functional elements of the network entity to perform the described functions. Additionally, or alternatively, the network entity may perform aspects of the described functions using special-purpose hardware.

At 2505, the method may include obtaining a capability message indicating a capability of a UE (e.g., a UE 115, UE 115-a, a discard timer manager 245, a UE 115-b, a UE 115-c) to perform a discard timer selection procedure for a discard timer associated with a PDCP layer of a protocol stack (e.g., a protocol stack 205) of the UE. The operations of 2505 may be performed in accordance with examples as disclosed herein. In some examples, aspects of the operations of 2505 may be performed by a capability transmission manager 2225 as described with reference to FIG. 22.

At 2510, the method may include performing, based on the capability message, a selection parameter selection procedure to obtain one or more selection parameters for the discard timer selection procedure of the UE. The operations of 2510 may be performed in accordance with examples as disclosed herein. In some examples, aspects of the operations of 2510 may be performed by a selection parameter manager 2230 as described with reference to FIG. 22.

At 2515, the method may include transmitting, based on performing the selection parameter selection procedure, a control message indicating the one or more selection parameters. The operations of 2515 may be performed in accordance with examples as disclosed herein. In some examples, aspects of the operations of 2515 may be performed by a control signaling manager 2235 as described with reference to FIG. 22.

The following provides an overview of aspects of the present disclosure:

Aspect 1: A method for wireless communications by a UE, comprising: receiving, based at least in part on a capability of the UE to perform a discard timer selection procedure for one or more discard timers configured for a PDCP layer of a protocol stack of the UE, a control message indicating one or more selection parameters for the discard timer selection procedure; performing, based at least in part on the one or more selection parameters, the discard timer selection procedure to obtain a discard timer value for the one or more discard timers; and storing, at a buffer associated with the protocol stack of the UE, one or more PDCP SDUs associated with an uplink message for the UE, wherein each PDCP SDU of the one or more PDCP SDUs are associated with a respective discard timer of the one or more discard timers configured in accordance with the discard timer value.

Aspect 2: The method of aspect 1, further comprising: performing, based at least in part on storing the one or more PDCP SDUs at the buffer, an SDU release procedure by dropping a PDCP SDU of the one or more PDCP SDUs from the buffer based at least in part on expiration of the respective discard timer associated with the PDCP SDU.

Aspect 3: The method of aspect 2, further comprising: performing, based at least in part on performing the SDU release procedure, one or more discard timer characteristic measurement procedures to obtain data associated with the respective discard timer associated with the PDCP SDU of the one or more PDCP SDUs; performing, based at least in part on performing the one or more discard timer characteristic measurement procedures, an update procedure to update a machine learning model of the UE according to the data; and performing, based at least in part on performing the update procedure, a second discard timer selection procedure to obtain an updated discard timer value for the one or more discard timers using the updated machine learning model.

Aspect 4: The method of aspect 3, further comprising: performing, based at least in part on performing the second discard timer selection procedure, an accuracy monitoring procedure to determine whether the updated discard timer value satisfies one or more key performance indicators.

Aspect 5: The method of any of aspects 1 through 4, further comprising: transmitting a capability message indicating the capability of the UE to perform the discard timer selection procedure for the one or more discard timers, the capability of the UE associated with a source cell, a target cell, or both, and is based at least in part on a buffer allocation value or buffer utilization threshold value, wherein the control message is received in response to the capability message.

Aspect 6: The method of any of aspects 1 through 5, wherein performing the discard timer selection procedure comprises: inputting one or more model input parameters into a machine learning model, wherein the one or more model input parameters comprise one or more radio conditions, one or more performance target parameters, one or more wireless communication traffic conditions, or a combination thereof; and obtaining, after inputting the one or more model input parameters, the discard timer value for the one or more discard timers from an output of the machine learning model for the discard timer selection procedure.

Aspect 7: The method of any of aspects 1 through 6, further comprising: transmitting, after performance of the discard timer selection procedure, an indication of the discard timer value for the one or more discard timers, wherein the discard timer value is for a single cell or for handover to a target cell.

Aspect 8: The method of any of aspects 1 through 7, wherein the one or more selection parameters comprise a buffer utilization threshold value, wherein performing the discard timer selection procedure comprises: obtaining the discard timer value using a machine learning model that is based at least in part on the buffer utilization threshold value.

Aspect 9: The method of any of aspects 1 through 8, further comprising: receiving a configuration message indicating one or more model input parameters, wherein the one or more model input parameters comprise a maximum discard timer value, a minimum discard timer value, a maximum packet discard rate, or a combination thereof, wherein performing the selection procedure comprises: inputting the one or more model input parameters into a machine learning model; and obtaining, after inputting the one or more model input parameters, the discard timer value for the one or more discard timers from an output of the machine learning model for the discard timer selection procedure.

Aspect 10: The method of any of aspects 1 through 9, wherein the one or more selection parameters comprise a QoS value, a logical channel, a CC, and a cell group, or a combination thereof, wherein performing the discard timer selection procedure comprises: obtaining one or more discard timer values using a machine learning model that is based at least in part on the QoS value, the logical channel, the CC, and the cell group, or the combination thereof.

Aspect 11: The method of any of aspects 1 through 10, further comprising: receiving a configuration indicating one or more model input parameters, wherein the one or more model input parameters comprise an identifier for one or more cells associated with a network entity, one or more cell measurement configurations, or a combination thereof, wherein performing the discard timer selection procedure comprises: inputting the one or more model input parameters into a machine learning model; and obtaining, after inputting the one or more model input parameters, the discard timer value for the one or more discard timers from an output of the machine learning model for the discard timer selection procedure.

Aspect 12: The method of any of aspects 1 through 11, wherein the one or more selection parameters comprise a key performance indicator violation report, an over-discarding indication, and a latency value, or a combination thereof, wherein performing the discard timer selection procedure comprises: obtaining the discard timer value using a machine learning model that is based at least in part on the key performance indicator violation report, the over-discarding indication, and the latency value, or the combination thereof.

Aspect 13: The method of any of aspects 1 through 12, further comprising: performing the discard timer selection procedure to obtain the discard timer value, wherein the discard timer value fails to satisfy one or more performance targets; and selecting, based at least in part on the discard timer value failing to satisfy the one or more performance targets, a second discard timer value for the one or more discard timers according to a fallback procedure associated with the PDCP layer of the protocol stack of the UE.

Aspect 14: A method for wireless communications at a network entity, comprising: obtaining a capability message indicating a capability of a UE to perform a discard timer selection procedure for a discard timer associated with a PDCP layer of a protocol stack of the UE; performing, based at least in part on the capability message, a selection parameter selection procedure to obtain one or more selection parameters for the discard timer selection procedure of the UE; and transmitting, based at least in part on performing the selection parameter selection procedure, a control message indicating the one or more selection parameters.

Aspect 15: The method of aspect 14, further comprising: obtaining, after outputting the control message, an indication of a discard timer value for the discard timer, wherein the discard timer value is for a single cell or for handover to a target cell.

Aspect 16: The method of any of aspects 14 through 15, wherein the one or more selection parameters comprise a buffer utilization threshold value.

Aspect 17: The method of any of aspects 14 through 16, wherein the one or more selection parameters comprise a QoS value, a logical channel, a CC, and a cell group, or a combination thereof.

Aspect 18: The method of any of aspects 14 through 17, wherein the one or more selection parameters comprise an identifier for one or more cells associated with the network entity.

Aspect 19: The method of any of aspects 14 through 18, wherein the one or more selection parameters comprise a key performance indicator violation report, an over-discarding indication, and a latency value, or a combination thereof.

Aspect 20: A UE for wireless communications, comprising one or more memories storing processor-executable code, and one or more processors coupled with the one or more memories and individually or collectively operable to execute the code to cause the UE to perform a method of any of aspects 1 through 13.

Aspect 21: A UE for wireless communications, comprising at least one means for performing a method of any of aspects 1 through 13.

Aspect 22: A non-transitory computer-readable medium storing code for wireless communications, the code comprising instructions executable by one or more processors to perform a method of any of aspects 1 through 13.

Aspect 23: A network entity for wireless communications, comprising one or more memories storing processor-executable code, and one or more processors coupled with the one or more memories and individually or collectively operable to execute the code to cause the network entity to perform a method of any of aspects 14 through 19.

Aspect 24: A network entity for wireless communications, comprising at least one means for performing a method of any of aspects 14 through 19.

Aspect 25: A non-transitory computer-readable medium storing code for wireless communications, the code comprising instructions executable by one or more processors to perform a method of any of aspects 14 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, based at least in part on a capability of the UE to perform a discard timer selection procedure for one or more discard timers configured for a packet data convergence protocol (PDCP) layer of a protocol stack of the UE, a control message indicating one or more selection parameters for the discard timer selection procedure;
perform, based at least in part on the one or more selection parameters, the discard timer selection procedure to obtain a discard timer value for the one or more discard timers; and
store, at a buffer associated with the protocol stack of the UE, one or more PDCP service data units (SDUs) associated with an uplink message for the UE, wherein each PDCP SDU of the one or more PDCP SDUs are associated with a respective discard timer of the one or more discard timers configured in accordance with the discard timer value.

2. The UE of claim 1, wherein the one or more processors are individually or collectively further operable to execute the code to cause the UE to:
perform, based at least in part on storing the one or more PDCP SDUs at the buffer, an SDU release procedure by dropping a PDCP SDU of the one or more PDCP SDUs from the buffer based at least in part on expiration of the respective discard timer associated with the PDCP SDU.

3. The UE of claim 2, wherein the one or more processors are individually or collectively further operable to execute the code to cause the UE to:
perform, based at least in part on performing the SDU release procedure, one or more discard timer characteristic measurement procedures to obtain data associated with the respective discard timer associated with the PDCP SDU of the one or more PDCP SDUs;
perform, based at least in part on performing the one or more discard timer characteristic measurement procedures, an update procedure to update a machine learning model of the UE according to the data; and
perform, based at least in part on performing the update procedure, a second discard timer selection procedure to obtain an updated discard timer value for the one or more discard timers using the updated machine learning model.

4. The UE of claim 3, wherein the one or more processors are individually or collectively further operable to execute the code to cause the UE to:
perform, based at least in part on performing the second discard timer selection procedure, an accuracy monitoring procedure to determine whether the updated discard timer value satisfies one or more key performance indicators.

5. The UE of claim 1, wherein the one or more processors are individually or collectively further operable to execute the code to cause the UE to:
transmit a capability message indicating the capability of the UE to perform the discard timer selection procedure for the one or more discard timers, the capability of the UE associated with a source cell, a target cell, or both, and is based at least in part on a buffer allocation value or buffer utilization threshold value, wherein the control message is received in response to the capability message.

6. The UE of claim 1, wherein, to perform the discard timer selection procedure, the one or more processors are individually or collectively operable to execute the code to cause the UE to:
input one or more model input parameters into a machine learning model, wherein the one or more model input parameters comprise one or more radio conditions, one or more performance target parameters, one or more wireless communication traffic conditions, or a combination thereof; and
obtain, after inputting the one or more model input parameters, the discard timer value for the one or more discard timers from an output of the machine learning model for the discard timer selection procedure.

7. The UE of claim 1, wherein the one or more processors are individually or collectively further operable to execute the code to cause the UE to:
transmit, after performance of the discard timer selection procedure, an indication of the discard timer value for the one or more discard timers, wherein the discard timer value is for a single cell or for handover to a target cell.

8. The UE of claim 1, wherein, wherein the one or more selection parameters comprise a buffer utilization threshold value, wherein to perform the discard timer selection procedure, the one or more processors are individually or collectively operable to execute the code to cause the UE to:
obtain the discard timer value using a machine learning model that is based at least in part on the buffer utilization threshold value.

9. The UE of claim 1, wherein the one or more processors are individually or collectively further operable to execute the code to cause the UE to:
receive a configuration message indicating one or more model input parameters, wherein the one or more model input parameters comprise a maximum discard timer value, a minimum discard timer value, a maximum packet discard rate, or a combination thereof, wherein performing the selection procedure comprises:
inputting the one or more model input parameters into a machine learning model; and
obtaining, after inputting the one or more model input parameters, the discard timer value for the one or more discard timers from an output of the machine learning model for the discard timer selection procedure.

10. The UE of claim 1, wherein the one or more selection parameters comprise a quality of service (QOS) value, a logical channel, a component carrier (CC), and a cell group, wherein, to perform the discard timer selection procedure, the one or more processors are individually or collectively operable to execute the code to cause the UE to:
obtain one or more discard timer values using a machine learning model that is based at least in part on the QoS value, the logical channel, the CC, and the cell group, or the combination thereof.

11. The UE of claim 1, wherein the one or more processors are individually or collectively further operable to execute the code to cause the UE to:
receive a configuration indicating one or more model input parameters, wherein the one or more model input parameters comprise an identifier for one or more cells associated with a network entity, one or more cell measurement configurations, or a combination thereof, wherein performing the discard timer selection procedure comprises:
inputting the one or more model input parameters into a machine learning model; and
obtaining, after inputting the one or more model input parameters, the discard timer value for the one or more discard timers from an output of the machine learning model for the discard timer selection procedure.

12. The UE of claim 1, wherein the one or more selection parameters comprise a key performance indicator violation report, an over-discarding indication, and a latency value, or a combination thereof, wherein, to perform the discard timer selection procedure, the one or more processors are individually or collectively operable to execute the code to cause the UE to:
obtain the discard timer value using a machine learning model that is based at least in part on the key performance indicator violation report, the over-discarding indication, and the latency value, or the combination thereof.

13. The UE of claim 1, wherein the one or more processors are individually or collectively further operable to execute the code to cause the UE to:
perform the discard timer selection procedure to obtain the discard timer value, wherein the discard timer value fails to satisfy one or more performance targets; and
select, based at least in part on the discard timer value failing to satisfy the one or more performance targets, a second discard timer value for the one or more discard timers according to a fallback procedure associated with the PDCP layer of the protocol stack of the UE.

14. A network entity, comprising:
one or more memories storing processor-executable code; and
one or more processors coupled with the one or more memories and individually or collectively operable to execute the code to cause the network entity to:
obtain a capability message indicating a capability of a UE to perform a discard timer selection procedure for a discard timer associated with a packet data convergence protocol (PDCP) layer of a protocol stack of the UE;
perform, based at least in part on the capability message, a selection parameter selection procedure to obtain one or more selection parameters for the discard timer selection procedure of the UE; and
transmit, based at least in part on performing the selection parameter selection procedure, a control message indicating the one or more selection parameters.

15. The network entity of claim 14, wherein the one or more processors are individually or collectively further operable to execute the code to cause the network entity to:
obtain, after outputting the control message, an indication of a discard timer value for the discard timer, wherein the discard timer value is for a single cell or for handover to a target cell.

16. The network entity of claim 14, wherein the one or more selection parameters comprise a buffer utilization threshold value.

17. The network entity of claim 14, wherein the one or more selection parameters comprise a quality of service (QOS) value, a logical channel, a component carrier (CC), and a cell group, or a combination thereof.

18. The network entity of claim 14, wherein the one or more selection parameters comprise an identifier for one or more cells associated with the network entity.

19. The network entity of claim 14, wherein the one or more selection parameters comprise a key performance indicator violation report, an over-discarding indication, and a latency value, or a combination thereof.

20. A method for wireless communications by a user equipment (UE), comprising:
receiving, based at least in part on a capability of the UE to perform a discard timer selection procedure for one or more discard timers configured for a packet data convergence protocol (PDCP) layer of a protocol stack of the UE, a control message indicating one or more selection parameters for the discard timer selection procedure;
performing, based at least in part on the one or more selection parameters, the discard timer selection procedure to obtain a discard timer value for the one or more discard timers; and
storing, at a buffer associated with the protocol stack of the UE, one or more PDCP service data units (SDUs) associated with an uplink message for the UE, wherein each PDCP SDU of the one or more PDCP SDUs are associated with a respective discard timer of the one or more discard timers configured in accordance with the discard timer value.
